(19) United States
(12) Patent Application Publication
(10) Pub. No.: US 2019/0255536 A1
(43) Pub. Date: Aug. 22, 2019

(54) APPARATUS AND METHOD FOR FILTERING

(71) Applicant: Paul Neiser, Mountain View, CA (US)

(72) Inventor: Paul Neiser, Mountain View, CA (US)

(21) Appl. No.: 16/278,705

(22) Filed: Feb. 18, 2019

Related U.S. Application Data
(60) Provisional application No. 62/710,602, filed on Feb. 17, 2018.

(51) Int. Cl. B03C 1/28; B03C 1/033

(52) U.S. Cl. CPC B03C 1/288; B03C 1/0335

(57) ABSTRACT

Apparatus and methods for selectively transmitting objects of interest from a first reservoir to a second reservoir are disclosed. The apparatus includes electromagnetic focusing apparatus configured to interact with objects of interest to induce a change in a property of the objects of interest so as to increase the probability that the objects of interest through a throat diffusively coupling the first reservoir and the second reservoir.

This application claims the benefit under 35 U.S.C. § 119(e) of U.S. Provisional Application No. 62/710,602 filed on Feb. 17, 2018, and U.S. Provisional Application No. 62/710,341 filed on Feb. 15, 2018, each of which is incorporated by reference in its entirety.

### FIELD

The invention relates to apparatus and methods for selectively transmitting objects of interest from a first reservoir to a second reservoir. The apparatus includes electromagnetic focusing apparatus configured to interact with objects of interest to induce a change in a property of the objects of interest so as to increase the probability that the objects of interest through a throat diffusively coupling the first reservoir and the second reservoir.

### BACKGROUND

Selectively transmitting objects of interest across a membrane can be useful in applications such as filtering and generating thrust.

### SUMMARY

According to the present invention, apparatus units for selectively transmitting objects of interest, wherein the apparatus unit comprise a bulk material; a throat disposed within the bulk material and extending from a first throat opening to a second throat opening opposite the first throat opening; and wherein the throat has length that is less than 1000 mean free path lengths of the objects of interest before interacting with the apparatus unit; and a first focusing apparatus, wherein the first focusing apparatus is disposed within the bulk material and in proximity to at least a portion of the throat.

According to the present invention, methods of selectively transmitting objects of interest from a first reservoir to a second reservoir, comprise providing the apparatus unit provided by the present disclosure, wherein the first throat opening is diffusively coupled to the first reservoir and the second throat opening diffusively coupled to the second reservoir; and generating a force field by activating the first focusing apparatus, to thereby selectively transmit objects of interest from the first reservoir to the second reservoir.

### BRIEF DESCRIPTION OF THE DRAWINGS

The drawings described herein are for illustration purposes only. The drawings are not intended to limit the scope of the present disclosure.

FIG. 1 shows a cross-sectional view of an apparatus according to the present invention.

FIG. 2 shows a cross-sectional view of an apparatus according to the present invention.

FIG. 3 shows a top view of an embodiment configured in a similar manner as the embodiment shown in FIG. 1.

FIG. 4 shows a top view of an embodiment configured in a similar manner as the embodiment shown in FIG. 2.

FIG. 5 shows a top view of another embodiment configured in a similar manner as the embodiment shown in FIG. 2.

FIG. 6 shows a cross-sectional view of an embodiment configured to interact with polarized objects of interest.

FIG. 7 shows a cross-sectional view of another embodiment configured to interact with polarized objects of interest.

FIG. 8 shows a cross-sectional view of an embodiment configured to interact with charged particles.

FIG. 9 shows an example application of embodiments of the invention. In this example, embodiments of the invention are employed in a turboshaft engine or turbojet engine.

FIG. 10 is a cross-sectional view of an application of an embodiment of the invention in an electrical power supply.

FIG. 11 is a cross-sectional view of an application of an embodiment of the invention in a heat transfer apparatus.

FIG. 12 is a plot of the value of pressure versus specific volume of gas which passes through an example embodiment of the invention, such as the example embodiment shown in FIG. 9.

### DETAILED DESCRIPTION OF THE DRAWINGS

Provided is an apparatus and method for filtering objects based on a defining property of the objects.

The term “medium” used herein describes any material which is capable of containing, carrying, transporting, or transferring an object of interest. A medium may be a gas, a liquid, a solid, or a vacuum, for example. By default, a medium refers to the collection of all objects which interact with a specified apparatus.

The term “object” used herein describes any component of a medium. An object may be described as a particle, such as a dust particle, a soot particle, a water droplet, a water molecule. An object may have a property of interest, as well as a defining property, which may be used to distinguish an object from other objects of the medium. The invention applies to any medium which can be considered to comprise distinct objects.

One can define a “default boundary condition” as a simplified scenario in which the properties of the medium at a first reservoir and a second reservoir are identical and uniform in time and space.

The “baseline scenario” is a scenario in which the filtering apparatus in question is replaced by a “baseline apparatus”, defined as a solid, impenetrable, flat plate, and subjected to default boundary conditions.

One can define a “baseline probability” as the probability for any object which interacts with a baseline apparatus to be located at a specified side of the baseline apparatus after the interaction is completed in a baseline scenario. In this case, the baseline probability is 50% for both sides of the baseline apparatus.

Unless specified or clear from context, the term “or” is equivalent to “and/or” throughout this paper.

Apparatus and systems provided by the present disclosure are configured to interact with objects of interest in a medium so that the component of transmissivity of the objects of interest in a first direction is larger than the transmissivity of the objects of interest in a second direction. The medium can be a gas, a liquid, or a solid. The object of interest can be, for example, a photon, a phonon, an electron, an atom, a molecule, a particle, an aerosol, an electromagnetic wave, or a quasiparticle.

Transmissivity refers to the probability that an object of interest having a velocity in a specified range of directions after interacting with an apparatus or system provided by the present disclosure, where the objects of interest had a velocity with a direction outside the specified range of directions before interaction with an apparatus or system provided by the present disclosure. For example, the transmissivity of an object can refer to the probability that the objects of interest in a first reservoir pass through an apparatus or system provided by the present disclosure and into a second reservoir. The direction of transmissivity with respect to a surface of an apparatus can be at any angle. The transmissivity of an object of interest can be facilitated by the apparatus changing a property of the objects of interest before entering the apparatus at one or more bidirectional interfaces. The change in property can be induced by an electromagnetic field such as an electric field or a magnetic field. The bidirectional interfaces can define a channel through a bulk material. A property of interest can be a vector property of an object of interest and/or can be a number density of the objects of interest. For a vector property an apparatus can interact with the objects of interest to increase the probability or decrease the probability of the objects of interest will pass through the bidirectional interface. The apparatus can be configured such that the interaction can increase or decrease the number density of the objects of interest in a reservoir diffusively coupled to the bidirectional interface. The interaction can comprise focusing and/or defocusing trajectories of the objects of interest toward the bidirectional interface or away from the bidirectional interface. The average length of the path followed by an object of interest through the bidirectional interface can be on the order of the mean free path length of the object prior to interaction of the object with the apparatus.

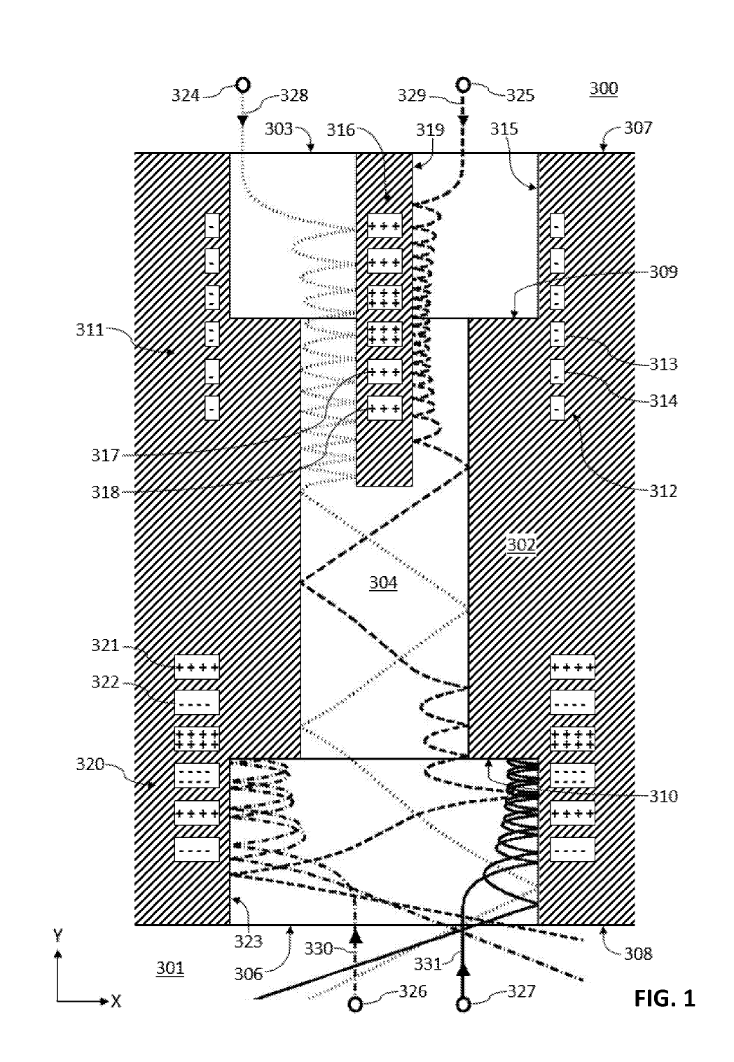

FIG. 1 is a cross-sectional view of an embodiment of the invention.

In FIG. 1, the medium is schematically represented by individual particles, such as the schematic representation of particle 324. Each particle follows a trajectory in three-dimensional space. The 2D projection on the XY-plane of such a trajectory is also shown, such as in the form of trajectory 220. For simplicity, the medium can be considered to be a monatomic ideal gas. In other embodiments the object or particle may have any shape or spatial extent, including a shape that is not spherically symmetric, such as the shape of a dinitrogen molecule.

There is a first reservoir 300 and a second reservoir 301. The depicted apparatus has a first surface 307 and a second surface 308. In the configuration shown, the apparatus is stationary in the inertial XYZ-frame for simplicity in description and illustration.

A channel allows particles from the first reservoir 300 to pass through to the second reservoir 301. The portion of the channel between the first opening 303 and the first inside surface 309 is denoted the first channel. The portion of the channel between the second opening 306 and the second inside surface 310 is denoted the second channel. The first channel, the throat 304, and the second channel are collectively referred to as the “channel system”. All have a circular cross-section when viewed along the Y-direction. In other embodiments, the channel may have any cross-section, such as square, rectangular, or polygonal cross-sections. All components of an apparatus of an embodiment which can be associated with a particular channel system are referred to as an “apparatus unit”. An apparatus unit includes a first focusing apparatus 311, a second focusing apparatus 320, the channel system, as well as any bulk material 302 associated with the channel system. The interface between the channel associated with the first opening 303 and the throat 304 is denoted the first throat opening. The interface between the channel associated with the second opening 306 and the throat 304 is denoted the second throat opening. The channel system is enveloped by bulk material 302. The cross-sectional area of the throat 304 is smaller than the cross-sectional area of the first opening 303 and the cross-sectional area of the second opening 306.

In the case in which the objects of interest can be described as particles, such as molecules, bulk material 302 may be any solid material, such as a metal, ceramic, or composite. All accessible surfaces of material 302 are configured to perfectly reflect all objects of interest in the medium. In other embodiments, this need not be the case. Those skilled in the art will be able to choose an appropriate material for a given application.

There is a first focusing apparatus 311, which comprises an inside apparatus 316 and an outside apparatus 312. In the embodiment shown in FIG. 1, the particles are neutrally charged, but can be polarized by the application of an external electric field. A spatial gradient in said field can be used to apply an electrostatic force on the polarized particles. The first focusing apparatus 311 is configured to generate a first electric field which both polarizes and exerts forces on any particles of the medium in the proximity of the first focusing apparatus 311. One can define a radial direction, which is aligned with the outward normal of the cylindrical inner surface 319, and an axial direction, which is parallel to said surface, and the Y-axis. For example, the first electric field may be arranged as follows.

The magnitude of component of the electric field in the radial direction, or the “MCEFR”, may be configured to decrease along the radial direction in the proximity of inner surface 319, and in a substantial portion of the volume of the first channel and in the proximity of the first throat opening of throat 304. Due to this radial variation of the MCEFR, the maximum value of the MCEFR of the first focusing apparatus 311 at a given location along the Y-axis within the first channel and throat 304 may be located on the inner surface 319.

The MCEFR at a given radius is also configured to, in general, increase to a maximum value as the position along the Y-axis is decreased from the first opening 303 onwards, where the maximum is located approximately half-way along the length of the first focusing apparatus 311, or approximately where the first throat opening is located, for instance. Note that said general increase refers to an increasing trend. The MCEFR at a given radius, such as the radius of the bulk material of inner surface 319, may vary, oscillate, or fluctuate about a general, increasing trend as the location along the Y-axis is decreased from the first opening 303 to the first throat opening, for example. These spatial fluctuations may arise from the manner in which the electric field is generated, as will be explained later. As the position along the Y-axis is decreased further, the MCEFR at a given radius is configured to decrease approximately symmetrically to the aforementioned increase, in this embodiment. Thus, the maximum MCEFR for all locations along the Y-axis within the first channel and throat 304 is located on the inner surface 319, at a location along the Y-axis approximately corresponding to the location of the first throat opening.

The magnitude of the circumferential component of the electric field associated with the first focusing apparatus 311 is zero in this embodiment. The magnitude of the axial component of the electric field associated with the first focusing apparatus 311 varies with the location along the Y-axis and with radius. The length of the first focusing apparatus 311 along the Y-direction, as well as the spatial or temporal form of the electric field associated with the first focusing apparatus 311 depends on the application and can be optimized using methods known in the art.

The effect of the radially decreasing MCEFR is the attraction of polarized particles to the inner surface 319 in the proximity of the first focusing apparatus.

Such a field can be generated in a multitude of ways. In this embodiment, the field is generated by an arrangement of charged material within bulk material 302. An inside apparatus 316 comprises a positively charged apparatus. In this embodiment, said apparatus comprises several electrically insulated collections of charge, such as charge collection 317 and charge collection 318, where each collection may contain a different charge compared to adjacent collections. In this way, a desired spatial distribution of electrical field strength can be generated. Each charge collection of inside apparatus 316 is cylindrical in shape in the configuration shown. In this embodiment, the field is constant in time. The electrical insulation may be facilitated by an appropriate choice of electrically insulating bulk material. In other embodiments, the charge collections may insulated by a separate material. An outside apparatus 312 comprises negatively charged apparatus, where the total negative charge balances the total positive charge of inside apparatus 316. In other embodiments, there may be a net charge associated with the first focusing apparatus 311.

As before, said apparatus comprises several electrically insulated collections of charge, such as charge collection 314 and charge collection 313, where each collection may contain a different charge compared to adjacent collections. In this simplified example each charge collection of outside apparatus 312 is in the shape of a ring which encompasses the first channel and throat 304. As a result of these charge collections of the first focusing apparatus 311, there are electric field lines which emanate from the cylindrical inside apparatus 316 and are directed towards the first outer surface 315, which is also cylindrical in shape albeit with a larger radius than cylindrical inner surface 319. This accounts for the radial features of the resulting electric field, which in turn account for a portion of the aforementioned decrease in MCEFR along the radial direction in this particular embodiment.

The second focusing apparatus 320 is configured to generate a second electric field which both polarizes and exerts forces on any particles of the medium in the proximity of the second focusing apparatus 320. As before, one can define a radial direction, which is aligned with the outward normal of the cylindrical second outer surface 323, and an axial direction, which is parallel to said surface, and the Y-axis. For example, the second electric field may be arranged as follows.

For at least some portions or sections of the channel system in proximity of the second focusing apparatus 320, such as in the proximity of the second outer surface 323 and other portions of the second channel, or in the throat 304 in the proximity of the second throat opening, the MCEFR may be configured to increase in the radially outward direction, where the radially outward direction is associated with the circular cross-section of the cylindrical second channel, for instance. In this embodiment, for a given location along the Y-axis, the MCEFR is configured to increase in the radially outward direction for all portions of the second channel, and the portion of the throat 304 which is in proximity of the second focusing apparatus 320. For a given location along the Y-axis, the MCEFR reaches a maximum on the second outer surface 323 in the second channel and on the outer surface of the aforementioned portion of throat 304, and is increasing in the radial direction within said portions of the channel system.

The MCEFR at a given radius is also configured to, in general, increase to a maximum value as the position along the Y-axis is increased from the second opening 306 onwards, where the maximum is located approximately half-way along the length of the second focusing apparatus 320, or approximately where the second throat opening is located, for instance. As before, said general increase refers to an increasing trend. The MCEFR at a given radius, such as the radius describing the location of the second outer surface 323, may vary, oscillate, or fluctuate about a general, increasing trend as the location along the Y-axis is increased from the second opening 306 to the second throat opening, for example. These spatial fluctuations may arise from the manner in which the electric field is generated, as will be explained later. As the position along the Y-axis is increased further, the MCEFR at a given radius is configured to decrease approximately symmetrically to the aforementioned increase, in this embodiment. Thus, the maximum MCEFR for all locations along the Y-axis within the second channel and throat 304 is located on the second outer surface 323, at a location along the Y-axis approximately corresponding to the location of the second throat opening.

The magnitude of the circumferential component of the electric field associated with the second focusing apparatus 320 is zero in this embodiment. The magnitude of the axial component of the electric field associated with the second focusing apparatus 320 varies with the location along the Y-axis and with radius. The length of the second focusing apparatus 320 along the Y-direction, as well as the spatial or temporal form of the electric field associated with the second focusing apparatus 320 depends on the application and can be optimized using methods known in the art.

The effect of the radially increasing MCEFR is the attraction of polarized particles to the second outer surface 323, and to the outer surface of throat 304 in the proximity of the second focusing apparatus 320.

Such a field can be generated in a multitude of ways. In this embodiment, the field is generated by an arrangement of positively and negatively charged material within bulk material 302. In this embodiment, said apparatus comprises several electrically insulated collections of charge, such as charge collection 321 and charge collection 322, where each collection may contain a different amount of charge compared to adjacent collections. In this way, a desired spatial distribution of electrical field strength can be generated. In this simplified example each charge collection of the second focusing apparatus 320 is in the shape of a ring which encompasses the second channel and throat 304. In this embodiment, the field is constant in time. The electrical insulation may be facilitated in a similar manner as described in the context of first focusing apparatus 311. The net charge of the second focusing apparatus 320 is zero. In other embodiments, there may be a net charge associated with the second focusing apparatus 320. There are concentrations of electric field lines which emanate from localized areas of second outer surface 323 in the proximity of the charge collections of the second focusing apparatus 320. This non-uniform concentration of electric field lines accounts for the aforementioned increase in MCEFR along the radially outward direction in this particular embodiment.

In other embodiments, the collections of charge of the second focusing apparatus 320 may not form aforementioned rings, but may be discretized in the circumferential direction, as well. Thus, the electric field lines can be concentrated in the circumferential as well as the axial direction, leading to regions or sections of the channel system with a more strongly increasing MCEFR in the radially outward direction towards the second outer surface 323 and towards the outer surface of throat 304 in the proximity of the second focusing apparatus 320. In some embodiments, such concentrations of electric field lines can be generated by individual atoms or molecules of the second focusing apparatus 320. In this case the interaction between the particles of the medium and the second focusing apparatus 320 can be described as a dipole-dipole interaction, or a van der Waals interaction, as opposed to a dipole-charge interaction shown in FIG. 1. In other embodiments, aforementioned adjacent rings in FIG. 1 need not have an opposite charge, but can have a similar charge. This also applies to any discrete collections of charge associated with a focusing apparatus.

The collections of charge may be comprised of conducting material, such as copper, which may be electrically connected to a source of electric potential, such as a battery terminal. In other embodiments, the collections of charge are generated by the embedding of ions in an electrically insulating or semiconducting host material, such as bulk material 302. Such methods are well known in the art.

In other embodiments, the strength of the electric field can be regulated over time in order to control the interaction of the apparatus with the medium. An appropriate electric field distribution in time and space can be determined using methods known in the art.

In other embodiments the objects may have a permanent dipole, such as is the case for water molecules. The objects may also carry a permanent charge, such as an ion, or an electron. In this case, the first and second focusing apparatuses may use the electric field instead of the gradient of the electric field in order to deflect the objects. In this case the interaction between a focusing apparatus and an object may be described as a charge-charge interaction. Alternatively, a magnetic field can be used to focus the trajectories of such objects. Such methods are well known in the art, such as in the context of electron microscopes.

In general terms, one can describe the purpose of the first and second focusing apparatuses to be the generation of a force field. A force field is a vector field which defines the magnitude and direction which an object of interest would experience at a specified location at a specified time. An “object of interest” is the object which the apparatus of the invention is intended to interact with in the aforementioned manner. For example, within a conductor, such as a metal, the free or conducting electrons may be objects of interest, while the lattice atoms, or the bound electrons and nuclei, are other objects of the medium surrounding the apparatus. Note that the force field can vary in time and space, and may also be a function of the properties of a specified object at the specified point in space and time. For example, in the case in which the forces of the force field arise from the interaction of a charged particle with a magnetic field, the force at a specified location and time is also a function of the velocity of said particle. In accordance with some embodiments of the invention, the force field of a focusing apparatus is configured to modify the position, e.g. by deflecting, or to modify the shape of objects, through the action of attraction or repulsion by a force field generating apparatus, in a manner in which the uniformity of a medium in time or space, in the case of a default boundary condition, is disturbed by an extent which exceeds any expected, microscopic fluctuations of said medium. Note that an aforementioned force field may interact with or exert forces on an object in a manner in which moments or torques are acting about the center of mass of an object. The term “force field” therefore also encompasses any field which can be considered to be a torque or moment field. The force field may in some embodiments also be described or expressed in terms of a potential field. Examples of repulsion are the electrostatic repulsion between like charges and the reflection of photons by a mirror, or particles by a surface. Examples of attraction are the gravitational force, the van der Waals force, the electrostatic attraction between unlike charges, or the interaction between an electric field gradient generating apparatus and an electrically polarized particle. These disturbances need not involve a change in the average energy of an object. In some embodiments, or some applications, the average energy of an object may change throughout an interaction, where the change nevertheless provides an improvement on the prior art, as measured by an objective function.

These artificial disturbances can be configured to increase or decrease a property of interest of objects of a specified defining property at a specified interface between a first and second reservoir, where the interface may be the second throat opening, where the defining property may be the location of the object of interest in a first or second reservoir prior to interacting with an apparatus of the invention, where the property of interest may be the number of objects per unit volume, and where the increase or decrease is measured relative to the corresponding properties of the medium for a baseline scenario. For example, a first focusing apparatus may be configured to artificially increase the density of objects originating at a first reservoir at the second throat opening, where the density increase refers to a density which is, on average, larger than the density of objects of the medium in the first reservoir for a baseline scenario. In some embodiments, an additional second focusing apparatus may be configured to artificially decrease the density of objects originating at a second reservoir at the second throat opening, where the density decrease refers to a density which is, on average, lower than the density of objects of the medium in the second reservoir for a baseline scenario. As a result there may be a net diffusion of a property of interest from a first reservoir 300 to a second reservoir 301.

In other embodiments, the first and second focusing apparatus generate the aforementioned force field in a different manner. For example, the forces may originate from van der Waals interactions between objects of a focusing apparatus and objects of the medium. For example, the inner surface 319 or the second outer surface 323 may be constructed of material with a non-zero force interaction, van der Waals or otherwise, with objects of the medium. The first surface 307 may also be constructed of the same material in order to enhance the focusing effect. To that end, the first surface 307 may furthermore be configured to guide objects of the medium to the first opening 303. The outward normal of the first surface 307 associated with a first channel may have a radially inward component, for example. The aforementioned non-zero force interaction can deflect or adsorb objects of the medium, after which these objects may diffuse along the surface. In the case of the inner surface 319, these objects may, after having been adsorbed or deflected by said force interaction, diffuse through the first throat opening, thus achieving an intended focusing effect. Once within the throat, these objects may desorb or escape the force field of the inner surface 319 and the first focusing apparatus 311. The geometry of the throat may furthermore be configured in such a way, that, on average, a sufficient fraction of these objects subsequently diffuse to the second throat opening, where sufficiency may be determined by an objective or intended purpose of the apparatus. For example, the normal of the inside surface of the throat may have a component in the negative Y-direction throughout the throat 304, or at a suitable location in the throat 304. The first outer surface 315 may have a negligible or comparatively smaller such van der Waals interaction in some embodiments in order to enhance the focusing effect of the first focusing apparatus. The inside surface of the throat, as well as any reflective surfaces, such as second inside surface 310 and second surface 308 may also have a negligible or smaller such interaction in order to facilitate the diffusion or reflection of objects of the medium. The appropriate material selection for different surfaces, as well as a suitable geometry and arrangement of such surfaces, depends on the application and can be found by those skilled in the art.

In the context of the simplified embodiment in FIG. 1, one can define an interaction between a particle and the depicted apparatus to commence when a particle passes through, intersects, or comes into contact with, planes containing the first surface 307 or the second surface 308, where the planes are parallel to the XZ-plane, and where the direction of travel prior to the interaction is in the opposite direction of the outward normal of the associated surface of the bulk material, which is directed in the positive Y-direction for the first surface 307, and the negative Y-direction for the second surface 308. These planes are denoted the first plane, and the second plane, respectively. An interaction can be defined to end when a particle no longer intersects or is in contact with the aforementioned planes. Said “contact” can in this case be defined as the existence of a non-negligible force between an object of the medium and an object of the apparatus, such as an object of bulk material 302.

One can define “input properties of interest” and “output properties of interest” as the properties of interest of a specified class of objects immediately before and immediately after interacting in a non-negligible manner with an embodiment of the invention, respectively. A property of interest may be the location of an object in either the first reservoir 300 or the second reservoir 301. The interaction of an object of interest with the apparatus of the invention can be described in terms of the difference between the input and output properties of interest. For example, an interaction can be described as either a transmission from the one reservoir to another reservoir, or a reflection back into the reservoir the object was located in before the interaction began. By definition, the type of interaction is a function of the “defining properties” of an object. The set of defining properties of the objects of interest may comprise the properties which distinguish the object of interest from other objects of the surrounding medium. In the embodiment shown in FIG. 1, the set of defining properties of an object also includes the input property of interest, i.e. the location of an object in either the first reservoir 300 or the second reservoir 301 immediately before interacting in a non-negligible manner with an embodiment of the invention. Throughout an interaction, an apparatus configured and operated in accordance with the invention will distinguish between or filter objects based on the value of the defining property of an object. In other words, the expected value of the type of interaction between a specified class of objects with at least one specified defining property and an embodiment of the invention is not equal to the expected value of the type of interaction of objects of the same specified class but different specified defining property. The expected value is the statistical expectation calculated for all objects contained within at least one specified class of objects which interact with an embodiment of the invention in a sufficiently long duration of time to provide a sufficiently accurate result. By default, a class of objects comprises all objects which interact with a specified apparatus.

In the context of this generation of embodiments, an embodiment of the invention is configured to focus objects originating at a first reservoir 300 before they arrive at an interface to the second reservoir 301, such as a second throat opening. The focusing or collection of objects is facilitated by a first focusing apparatus 311. In this way, the probability of an object arriving at the second throat opening to have originated at the first reservoir 300 is increased beyond the baseline probability of 50%. The embodiment shown in FIG. 1 is also configured to focus and reflect objects originating at a second reservoir 301 before they arrive at an interface to the first reservoir 300, such as the second throat opening. The focusing of objects is facilitated by a second focusing apparatus 320, while the reflection is accomplished by a second inside surface 310. From the perspective of the second throat opening, the second focusing apparatus 320 can be considered to defocus objects originating at a second reservoir 301. In this way, the probability of an object arriving at the second throat opening to have originated at the second reservoir 301 is decreased below the baseline probability of 50%.

As a result there may be a net diffusion of a property of interest from a first reservoir 300 to a second reservoir 301. In other embodiments, other such focusing mechanisms may be used. There are a wide variety of such methods known in the art for any given application. Once the default boundary condition is removed, and the first and second reservoirs are assumed to be finite in size and otherwise isolated from each other and any other reservoirs, the concentration of objects of interest in the first reservoir could be reduced over time, while the concentration of objects in the second reservoir could be increased correspondingly. Embodiments of the invention can thus also be considered for pumping applications. Connecting several stages of the apparatus shown in FIG. 1 in series, i.e. allowing the second reservoir of a first apparatus to coincide with the first reservoir of a second apparatus, could achieve a desired steady-state concentration of objects of interest in a first reservoir 300.

In this particular embodiment, the aforementioned focusing is accomplished by the increasing and decreasing MCEFR in a radial direction. For example, for the first focusing apparatus 311, the MCEFR decreases the radial direction, resulting in a polarization of particles of the medium in the proximity of cylindrical inner surface 319, and the attraction of these polarized particles to said surface. Consider the trajectory 328 of particle 324, which has a non-zero velocity component in the negative Y-direction and is located in the first reservoir 300 preceding the interaction with the depicted apparatus. As the particle enters the electric field of the first focusing apparatus 311, it is polarized and, due to the radial gradient of the MCEFR, attracted to inner surface 319. Since bulk material 302 is perfectly reflective in this simplified example, the particle will reflected from said surface. The attraction and reflection may repeat several times, in the form of bounces. The increasing MCEFR for a given radius in the negative Y-direction in the first channel results in a larger radially inward force experienced by a particle due to an increasing magnitude of the polarization of a particle and an increasing radial gradient of the MCEFR, for example. Hence the amplitude of the ensuing bounces decreases as the location of the particle along the Y-axis decreases. In the case of trajectory 328, the peak amplitude of the bounces at the location of the first throat opening is small enough for particle 324 to diffuse into throat 304. Once inside throat 304, the particle may continue to diffuse in the negative Y-direction, resulting in a departure from the force field of first focusing apparatus 311 and a passage through the second throat opening and the second channel into the second reservoir 301. Particle 324 is only temporarily affected by the second focusing apparatus 320 in that process. Trajectory 329 of particle 325 shows a similar interaction. Particle 326 has a non-zero velocity component in the positive Y-direction and is located in the second reservoir 301 preceding the interaction with the depicted apparatus. As indicated by trajectory 330, as particle 326 enters the electric field of the second focusing apparatus 320, it is polarized and, due to the radial gradient of the MCEFR, attracted to second outer surface 323, from where it is subsequently reflected. The amplitude of the ensuing bounces decreases owing to the larger radially outward force experienced by particle 326 due to the increasing MCEFR for a given radius in the positive Y-direction in the second channel. The amplitude of a bounce is sufficiently small at the location of the second throat opening, that particle 326 is reflected by second inside surface 310 instead of diffusing into throat 304. Subsequently particle 326 diffuses back into the second reservoir 301. Trajectory 331 of particle 327 shows a similar interaction. Note that the XY-plane projection of the initial velocities of particles 324, 325, 326, and 327 are parallel to the Y-axis for clarity of illustration only. The velocity of other particles diffusing into and out of the first opening 303 or the second opening 306 can take any direction and magnitude also found in the medium of the respective reservoir 301 and consistent with the direction of said diffusion. Note that some particles which originate at the first reservoir 300 will return to the first reservoir 300 once the interaction is complete. Similarly, some particles which originate at the second reservoir 301 will be found at the first reservoir 300 once the interaction is complete. On average, however, the apparatus is configured in such a manner, that there is a net diffusion of particles from the first reservoir 300 to the second reservoir 301 throughout an interaction for the default boundary condition.

One can define a first capture surface as the surface describing the first opening 303, and the second capture surface as the surface describing the second opening 306, where first and second capture surfaces are parallel to the XZ-plane. In this embodiment, the associated first capture area is smaller than the second capture area. One can define a “first footprint surface” to be the total surface that forms an interface to the first reservoir 300 and is associated with an apparatus unit, i.e. the sum of the first capture surface and any portion of the first surface 307 associated with an apparatus unit. The boundary of the footprint surface of an apparatus unit is provided by the boundary of other footprint surfaces of adjacent apparatus units, where the apparatus units are, at least hypothetically, arranged periodically in the XZ-plane. For example, the boundary of a first footprint surface may have a hexagonal shape. Similarly, one can define a “second footprint surface” as the projection of the first footprint surface on the second surface 308. One can define a control volume which is bounded by the first footprint surface, the second footprint surface, as well as the surface parallel to the Y-axis connecting corresponding points of the first and second surface of the control volume. For the default boundary condition, the probability of an object of the medium being located in the first reservoir 300 prior to interacting with the first or second footprint surface is 50%, with the other 50% applying to the second reservoir 301. Since the first capture area is smaller than the second capture area, the probability of a particle entering the channel system from the first reservoir 300 is smaller than the probability of a particle entering the channel system from the second reservoir 301. The fraction of particles which enter the channel system via the first opening 303 and exit via the second opening 306 is denoted the “first transmissivity”. The fraction of particles which enter the channel system via the second opening 306 and exit via the first opening 303 is denoted the “second transmissivity”. For the default boundary condition, there will be a net flow rate of objects from the first reservoir 300 to the second reservoir 301 when the net diffusivity is greater than one, where the net diffusivity is calculated by multiplying the ratio of the first and second transmissivity by the ratio of the first and second capture area. In the embodiment shown, the first focusing apparatus 311 and the second focusing apparatus 320 are configured to ensure that the ratio of the first transmissivity to the second transmissivity is larger than one and large enough to compensate for a ratio of the first capture area to the second capture area which is smaller than one, such that the net diffusivity is greater than one. The geometry of the channel system, the configuration of the focusing apparatuses, and the ratio of the first capture area to the second capture area are examples of parameters that can be optimized by those skilled in the art in order to maximize an objective subject to constraints. The objective may be the net flow rate of a property of interest from the first reservoir 300 to the second reservoir 301.

The effectiveness of the depicted apparatus may be a function of the geometry and the scale, or the size, of the apparatus. The height of the depicted apparatus is defined to be the dimension of the apparatus along the Y-axis, i.e. the shortest distance between the first surface 307 and the second surface 308. It may be desirable to avoid excessive scattering amongst objects of interest, scattering between objects of interest and other objects of a medium, as well as any diffuse reflection by the walls within the channel system. Although such scattering behavior can be taken into account and, at least partially, compensated for in the configuration of the apparatus, it may degrade the intended performance of the apparatus, by reducing the first transmissivity or increasing the second transmissivity, for instance. In the absence of scattering, the initially necessarily negative Y-velocity component of a particle entering the channel system from the first reservoir 300, for example, is more likely to be maintained, which would enhance any desired focusing effects and first transmissivity. Other types of scattering may also apply to other embodiments of the invention.

There are several approaches for reducing such scattering. For example, the apparatus can be configured to reduce the expected number of reflections of objects by any reflective surfaces of an apparatus in order to reduce any reductions in transmissivity associated with diffuse reflections. The apparatus may also be configured to be of a small size in order to minimize the probability of scattering between objects of interest and other objects of a medium. In some embodiments it may also be possible to artificially exclude, filter, or remove such other objects of the medium from a channel system, while allowing a sufficient portion of objects of interest to interact with the channel system as intended. To maintain a high first transmissivity despite scattering amongst objects of interest, it may be desirable for the height of the apparatus to be smaller than a length several orders of magnitude larger than the mean free path of an object of interest in the medium for a default boundary condition, for example. More specifically, the length can be smaller than 1000 times the mean free path of an object of interest in an adjacent reservoir. In some embodiments, it may even be preferable for the height of the apparatus to be a fraction of the mean free path, where a fraction means less than one. By default, the height of an apparatus, i.e. the extent along the Y-direction, or the shortest distance between a first surface, such as first surface 307 and first surface 308, or the length of the centroid of a channel, is denoted the “characteristic length” of a channel. The “characteristic width of a channel” is the largest cross-sectional diameter of a channel, where the diameter is measured along the plane perpendicular to the centroid of the channel. For example, in FIG. 1, the characteristic width is the diameter of the throat 304. The size of the characteristic width is subject to similar considerations as the characteristic length of a channel. The width may also be within several orders of magnitude of the mean free path of an object of interest in the medium, for example. More specifically, the width can be smaller than 1000 times the mean free path of an object of interest in an adjacent reservoir. The width may also be a fraction of the mean free path, depending on the application and the properties of the medium. Note that in some cases, it may be possible and desirable to configure a medium in a way in which the objects of interest have a suitable mean free path length. Amongst other factors, suitability may be determined by the relation between the tolerances of a specified manufacturing method and the required size and shape resolution of an apparatus of the invention. The appropriate material, geometry, and method of manufacture can be found by those skilled in the art. Note that such size considerations apply to all embodiments of the invention, even though they may have a negligible effect for some applications.

An apparatus unit for selectively transmitting objects of interest provided by the present disclosure can comprise a bulk material; a throat disposed within the bulk material and extending from a first throat opening to a second throat opening opposite the first throat opening; and wherein the throat has length that is less than 1000 mean free path lengths of the objects of interest before interacting with the apparatus unit; and a first focusing apparatus, wherein the first focusing apparatus is disposed within the bulk material and in proximity to at least a portion of the throat.

The throat can have a length, for example, that is less than 1000 mean free path lengths of the objects of interest before interacting with the apparatus unit, less than 500 mean free path lengths, less than 250 mean free path lengths, less than 100 mean free path lengths, less than 10 mean free path lengths or less than 1 mean free path length. The throat can have a length, for example, from 0.1 mean free path lengths to 1000 mean free path lengths of the objects of interest before interacting with the apparatus unit, from 1 to 500, or from 10 mean free path lengths to 250 mean free path lengths.

The throat can have a width, for example, that is less than 1000 mean free path lengths of the objects of interest before interacting with the apparatus unit, less than 500 mean free path lengths, less than 250 mean free path lengths, less than 100 mean free path lengths, less than 10 mean free path lengths or less than 1 mean free path length. The throat can have a width, for example, from 0.1 mean free path lengths to 1000 mean free path lengths of the objects of interest before interacting with the apparatus unit, from 1 to 500, or from 10 mean free path lengths to 250 mean free path lengths.

The bulk material can comprise a first surface and a second surface opposite the first surface and the throat can extend from the first bulk material surface to the second bulk material surface. The throat can have a constant dimension throughout its length or can have sections with different dimensions throughout its length. For example, the throat can comprise a first channel at the first bulk material surface and/or a second channel toward the second bulk material surface and a narrow section coupling the first and second channels. A throat can comprise a first channel disposed within the bulk material and extending from a first opening to the first throat opening opposite the first opening and/or a second channel disposed within the bulk material extending from the second throat opening to a second opening.

The multiple sections of the throat can be co-aligned along a common linear or non-linear axis. The multiple sections can be asymmetrically situated with respect to a common axis.

A throat can have any suitable shape, which can vary throughout the length of the throat. For example, a throat or sections of a throat can have a circular, oval, rectangular, square, polygonal, or other suitable cross-sectional shape.

A focusing apparatus can be disposed within the bulk material in proximity to the throat. A focusing apparatus can be disposed in proximity to the first throat opening, in proximity to the second throat opening, and/or toward the middle of the throat. An apparatus unit can comprise one or more focusing apparatus.

A focusing apparatus can be configured to generate an electromagnetic field. The electromagnetic field can interact with objects of interest outside of the apparatus unit to increase the probability that the objects of interest will pass through the throat from one side of the apparatus unit to the other side. For example, an apparatus unit can separate a first reservoir from a second reservoir which are diffusively coupled through the throat. The electromagnetic field generated by the one or more focusing apparatus can interact with the objects of interest within the first and/or second reservoirs.

A focusing apparatus can comprise one or more charge collections and/or one or more magnetic dipoles disposed within the bulk material and in proximity to the throat such as, for example, in proximity to the first throat opening and/or the second throat opening.

The focusing apparatus can be configured to generate an electromagnetic field magnitude gradient. For example, an electromagnetic field magnitude gradient can increase toward a throat opening or can decrease toward a throat opening. An electromagnetic field magnitude gradient can increase toward the center of the focusing apparatus or decrease toward the center of the focusing apparatus. Other electromagnetic field magnitude gradients are possible.

A focusing apparatus can be in the shape of an annular ring that surrounds at least a portion of a throat. A focusing apparatus can comprise segments of an annular ring. A focusing apparatus can comprise, for example, a rectangular plate or a section of cylinder.

A focusing apparatus can comprise an inside focusing apparatus and/or an outside focusing apparatus. An inside focusing apparatus refers to an element that is disposed within at least a portion of the throat and includes elements such as one or more charge collections or dipole collections configured to generate an electromagnetic field. The electromagnetic field can be, for example, an electric field or a magnetic field. An outside focusing apparatus can be disposed within the bulk material an in alignment with at least a portion of the inside focusing apparatus. An outside focusing apparatus can comprise one or more charge collections or dipole collections.

Each of the one or more charge and dipole collections can be insulated from the bulk material.

A charge collection can be an electrically conductive material and can be electrically interconnected to a potential. A charge collection can comprise embedded electrons and/or ions in an electrically insulating or semiconducting material.

A dipole collection can comprise a magnetic material.

A focusing apparatus can be disposed in proximity to the first throat opening and/or the second throat opening and can be configured to pull objects of interest toward the bulk material in proximity to the first throat opening.

A focusing apparatus can be disposed in proximity to the first throat opening and/or the second throat opening and can be configured to repel objects of interest away from the bulk material in proximity to the first throat opening.

A bulk material can comprise a metal, a metal alloy, a ceramic, a composite, a thermoplastic, a thermoset, a semiconducting material, electrically insulating material, a semiconducting material, an electrically insulating material, a glass, or a combination of any of the foregoing. Inner surfaces of the bulk material forming the throat can be configured to reflect at lest a portion of the objects of interest.

Objects of interest can comprise, for example, electrically charged objects of interest can include electrons, ions or charged dust particles or aerosols, or permanent or induced electric dipoles, atoms, or molecules or permanent or induced magnetic dipoles, or combinations of any of the foregoing.

Objects of interest can be polarized, can comprise a permanent charge, or can be neutral.

The apparatus unit is configured to change a property of objects of interest in proximity to the first throat opening and/or the second throat opening. The change in property can be induced by interaction of the objects of interest with the one or more focusing apparatus.

A property can be, for example, the number density of the objects of interest at the first throat opening and/or the second throat opening.

A property is a vector property of the objects of interest at the first throat opening and/or the second throat opening. Vector properties can be associated with objects of interest such as photons, electrons, objects having a permanent or induced electric dipole, objects having a permanent or induced magnetic dipole, objects having as a polarization axis, or a combination of any of the foregoing. Changing a vector property can comprise, for example, changing the orientation of the objects of interest with respect to the geometry of the first throat opening and/or the second throat opening.

As a result of interacting with electromagnetic fields generated by the one or more focusing apparatus, the objects of interest comprise a first property before entering the throat from a first direction; and the objects of interest comprise a second property before entering the throat from a second direction, wherein the first property is different than the second property.

An apparatus unit can be disposed such that the first throat opening is diffusively coupled to a first reservoir with respect to the objects of interest of interest; and the second throat is diffusively coupled to a second reservoir with respect to the objects of interest of interest. Each of the first reservoir and the second reservoir independently can comprise an electromagnetic field. For example, a first reservoir can comprise a first reservoir focusing/defocusing apparatus within the first reservoir and in proximity to the first throat opening; and/or a second reservoir can comprise a second reservoir focusing/defocusing apparatus within the second reservoir and in proximity to the second throat opening. Each of the first reservoir and second reservoir focusing/defocusing apparatus can be independently configured to focus a trajectory of the objects of interest from a reflection trajectory to a transmission trajectory. Each of the first reservoir and second reservoir focusing/defocusing apparatus can be independently configured to change a trajectory of the objects of interest in the first reservoir and/or the second reservoir prior to interaction with the apparatus unit. Changing the trajectory can comprise changing the trajectory from a reflection trajectory to a transmission trajectory or changing the trajectory from a transmission trajectory to a reflection trajectory.

Systems provided by the present disclosure can comprise two or more of the apparatus units provided by the present disclosure, such as greater than 10 apparatus units, greater than 100, greater than 1,000, greater than 10,000, greater than 100,000, greater than 1,000,00, greater than 10,000,000, or greater than 100,000,000 apparatus units. The apparatus units can form a planar array of apparatus submits. A system can comprise planar arrays of apparatus units disposed next to each other within the same plane and/or can be disposed in a direction normal to another planar array. Apparatus units and planar arrays comprising apparatus units can be couple in series. For example, a second throat opening of a first apparatus unit is diffusively coupled to a first throat opening of a second apparatus unit.

Methods of selectively transmitting objects of interest from a first reservoir to a second reservoir provided by the present disclosure can comprise providing the apparatus unit provided by the present disclosure, wherein the first throat opening is diffusively coupled to the first reservoir and the second throat opening diffusively coupled to the second reservoir; and generating a force field by activating the first focusing apparatus, to thereby selectively transmit objects of interest from the first reservoir to the second reservoir.

Provided is an apparatus and method for filtering objects based on a defining property of the objects. The invention may be used for air purification, for example.

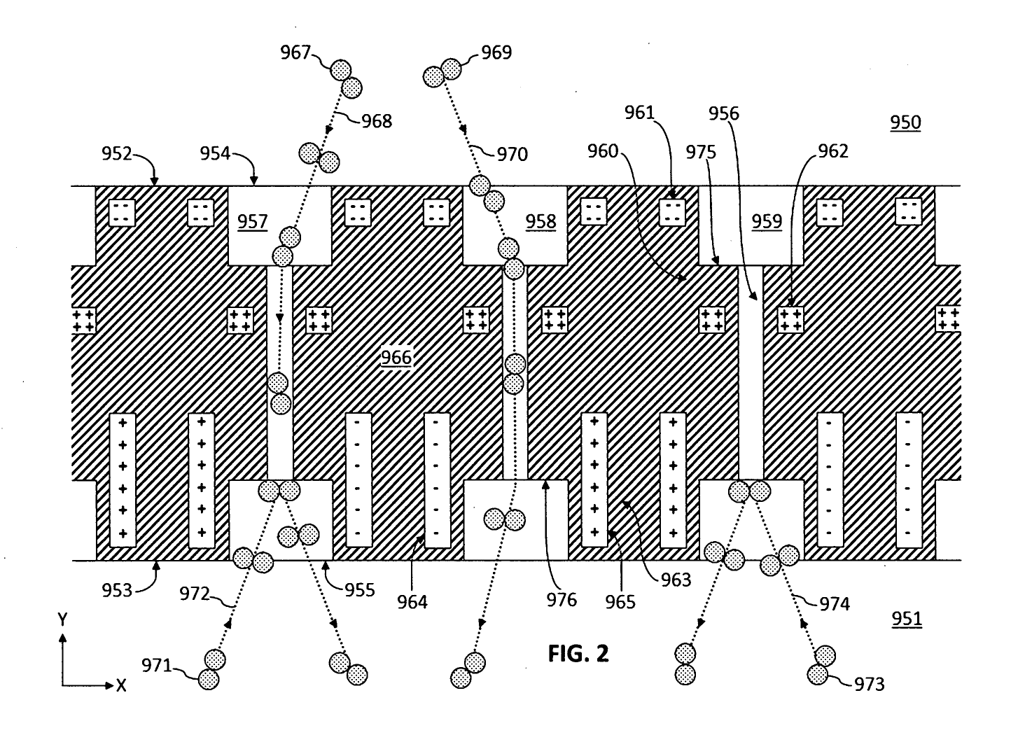

In FIG. 2, the medium is schematically represented by individual particles, such as the schematic representation of particle 967. Each particle follows a trajectory in three-dimensional space. The 2D projection on the XY-plane of such a trajectory is also shown, such as in the form of trajectory 968. For simplicity, the medium can be considered to be an ideal gas comprising diatomic molecules, such as particle 967. In other embodiments the object or particle may have any shape or spatial extent, including a shape that is nominally spherically symmetric, such as the shape of a hydrogen atom.

There is a first reservoir 950 and a second reservoir 951. The depicted apparatus has a first surface 952 and a second surface 953.

A channel allows particles from the first reservoir 950 to pass through to the second reservoir 951. The portion of the channel between the first opening, such as first opening 954, and a first inside surface, such as first inside surface 975, is denoted the first channel. The portion of the channel between a second opening, such as second opening 955, and a second inside surface, such as second inside surface 976, is denoted the second channel. The first channel, the throat 956, and the second channel are collectively referred to as the “channel system”, such as channel system 957, channel system 958, or channel system 959. The cross-section of the first channel and throat 956 is circular, while the cross-section of the second channel is square, where the normal of at least one face is aligned with the X-axis, and at least one face is coincident with a second inside surface, such as second inside surface 976. In other embodiments, the second channel may have a circular cross-section as well. Any channel may have any cross-section, such as square, rectangular, or polygonal cross-sections. All components of an apparatus of an embodiment which can be associated with a particular channel system are referred to as an “apparatus unit”. An apparatus unit includes a first alignment apparatus 960, a second alignment apparatus 963, the channel system, as well as any bulk material 966 associated with the channel system. The interface between the first channel and the throat 956 is denoted the first throat opening. The interface between the second channel and the throat 956 is denoted the second throat opening. The channel system is enveloped by bulk material 966. The cross-sectional area of the throat 956 is smaller than the cross-sectional area of the first opening 954 and the cross-sectional area of the second opening 955. In this embodiment, the cross-sectional area of the throat 956 is larger than the smallest cross-sectional area of a particle, but smaller than the largest cross-sectional area a particle may assume during an interaction with the depicted apparatus.

In the case in which the objects of interest can be described as particles, such as molecules, bulk material 966 may be any solid material, such as a metal, ceramic, or composite. All accessible surfaces of material 966 are configured to perfectly reflect all objects of interest in the medium. In other embodiments, this need not be the case. Those skilled in the art will be able to choose an appropriate material for a given application.

There is a first alignment apparatus 960, which comprises a first collection of charge 962 and a second collection of charge 961.

In the embodiment shown in FIG. 2, particles such as particle 967, are neutrally charged, but can be polarized by the application of an external electric field. In FIG. 2, there is furthermore a unique first principal polarization axis, or “FPPA”, associated with the polarizability tensor. The FPPA is defined to be parallel to the eigenvector corresponding to the largest eigenvalue of the polarizability tensor. In this case, when an applied, uniform electric field is not parallel to the instantaneous FPPA of a particle, the axis of polarization of a particle will not be aligned with the applied electric field. This results in a moment or torque, which acts to align the FPPA of a particle with the electric field. For example, when a stationary dipole is not aligned with a uniform electric field, the orientation of the dipole will oscillate about the orientation of the electric field due to the moment experienced by the dipole. Due to this oscillation, the particle will radiate energy in the form of electromagnetic radiation, which acts to dampen the magnitude of the oscillation. Once a sufficient amount of time has passed a sufficient amount of energy has been dissipated, a new equilibrium orientation, in which the dipole is aligned with the electric field, is reached. In FIG. 2, the FPPA is parallel to the long axis of the diatomic molecule, i.e. the axis formed by the line containing the centers of the nuclei of both atoms.

The first alignment apparatus 960 is configured to generate a first electric field which can both polarize and, under certain conditions, also exert forces and moments on any particles of the medium in the proximity of the first alignment apparatus 960. One can define a radial direction, which is aligned with the outward normal of the cylindrical inner surface of the first channel, and an axial direction, which is parallel to said surface and the Y-axis. For example, the first electric field may be arranged as follows.

The electric field within the first channel and a portion of the first throat opening is substantially aligned with the axial direction, i.e. the Y-axis, or the length of the throat 956. The effect of the field is an increased probability of an alignment of the FPPA of particles along the axial direction. This corresponds to the alignment of the long axis of a molecule with the Y-axis in the first channel and the first throat opening, which would decrease the cross-sectional area of a particle of the medium when viewed along the Y-axis compared to the reference scenario, in which the first alignment apparatus 960 is inactive and does not produce the aforementioned first field, and in which the orientation is random of a particle at the first throat opening is random. In some configurations, this circular cross-sectional area of a particle in the first channel and incident on the first throat opening is smaller than the circular cross-sectional area of the throat 956. This alignment can increase the probability of a particle from a first reservoir 950 entering the throat 956 compared to the reference scenario. In other embodiments, the FPPA may not be aligned with the long axis of a particle, or the desired orientation axis of a particle entering or within throat 956. In this case, the orientation of the electric field in the first channel and in the vicinity of the first throat opening can be configured in a way in which the FPPA is likely to be in an orientation or configuration which corresponds to the particle being oriented or configured to be able to enter throat 956.

The magnitude of the component of the electric field in the axial direction, or “MCEFA” associated with the first alignment apparatus 960 varies with the axial and radial direction. In the configuration shown, MCEFA increases as the position along the Y-axis is decreased from the position of the first opening 954 to the approximate position of the first throat opening. This gradient in the MCEFA has the additional beneficial effect of exerting a force in the negative Y-direction on a polarized particle with a non-zero polarization component in the positive Y-direction, i.e. aligned with the field, where the particle is located in the vicinity of the central axis of the first channel. This force can further increase the probability of a particle from a first reservoir 950 entering the throat 956 compared to the reference scenario.

The magnitude of the circumferential component of the electric field associated with the first alignment apparatus 960 is zero in this embodiment. The length of the first alignment apparatus 960 along the Y-direction, as well as the spatial or temporal form of the electric field associated with the first alignment apparatus 960 depends on the application and can be optimized using methods known in the art.

Such a field can be generated in a multitude of ways. In this embodiment, the field is generated by an arrangement of electrically insulated charged material within bulk material 966. The first alignment apparatus 960 comprises a positively charged first collection of charge 962, and a negatively charged second collection of charge 961. In this way, the desired spatial distribution of electric field magnitude and direction can be generated. The net charge associated with first alignment apparatus 960 is zero in this embodiment. In other embodiments, there may be a net charge associated with the first alignment apparatus 960. In this simplified example each charge collection of first alignment apparatus 960 is in the shape of a ring which encompasses the first channel and throat 956. As a result of these charge collections, there are electric field lines which emanate from the first collection of charge 962 and are directed substantially in the axial direction, aligned with the positive Y-direction in the throat 956 and the first channel in the proximity of the first throat opening. This accounts for the aforementioned axial features of the resulting electric field. In this embodiment, the field is constant in time. The electrical insulation may be facilitated by an appropriate choice of electrically insulating bulk material. In other embodiments, the charge collections may insulated by a separate material. In other embodiments, first alignment apparatus 960 may comprise more than two such distinct collections of charge, where each charge collection may have a different net charge than an adjacent charge collection. This may allow the electric field surrounding the first throat opening to be configured in a manner that more closely approximates the optimal electric field for a given objective.

The collections of charge may be comprised of conducting material, such as copper, which may be electrically connected to a source of electric potential, such as a battery terminal. In other embodiments, the collections of charge are generated by the embedding of ions in an electrically insulating or semiconducting host material, such as bulk material 966. Alternatively, dipoles may be embedded within bulk material 966, or on the interface of bulk material 966 with a channel system in order to produce the desired electric field in the proximity of the first throat opening. Such methods are well known in the art.

The second alignment apparatus 963 is configured to generate a second electric field which can both polarize and, under certain conditions, also exert forces and moments on any particles of the medium in the proximity of the second alignment apparatus 963. One can define a lateral direction, which is parallel to the X-axis, and a longitudinal direction, which is parallel to the Z-axis in the configuration shown. The axial direction is the same as the axial direction of the first alignment apparatus 960. For example, the second electric field may be arranged as follows.

The electric field within the second channel and a portion of the second throat opening is substantially aligned with the lateral direction. The effect of the field is an increased probability of alignment of the FPPA of particles along the lateral direction. This corresponds to the alignment of the long axis of a molecule with the X-axis in the second channel, which would increase the cross-sectional area of a particle of the medium when viewed along the Y-axis compared to the reference scenario in which the second alignment apparatus 963 is inactive and does not produce the aforementioned second field. In some configurations, this cross-sectional area of a particle in the second channel and incident on the second throat opening is larger than the circular cross-sectional area of the throat 956. This alignment can decrease the probability of a particle from a second reservoir 951 entering the throat 956 compared to the reference scenario.

The magnitude of the component of the electric field in the Y-direction, and in the Z-direction also varies with position. In the proximity of the second throat opening these components are negligible in this particular, simplified configuration, however. The length of the second alignment apparatus 963 along the Y-direction, as well as the spatial or temporal form of the electric field associated with the second alignment apparatus 963 depends on the application and can be optimized using methods known in the art.

Such a field can be generated in a multitude of ways. In this embodiment, the field is generated by an arrangement of electrically insulated charged material within bulk material 966. The second alignment apparatus 963 comprises a positively charged first collection of charge 965, and a negatively charged second collection of charge 964. The net charge associated with second alignment apparatus 963 is zero in this embodiment. In other embodiments, there may be a net charge associated with the second alignment apparatus 963. In this simplified example each charge collection of second alignment apparatus 963 is in the shape of a rectangular plate with the characteristic normal parallel to the X-axis. As a result of these charge collections, there are electric field lines which emanate from the second collection of charge 965 and are directed substantially in the lateral direction, aligned with the negative X-direction in the throat 956 and the second channel in the proximity of the second throat opening. This accounts for the aforementioned lateral features of the resulting electric field. Other configurations of the collections of charge of the second alignment apparatus 963 are known in the art and have been mentioned in the context of the first alignment apparatus 960.

In some embodiments, a desired electric field can be generated by individual atoms or molecules of the second alignment apparatus 963. In this case the interaction between the particles of the medium and the second alignment apparatus 963 can be described as a dipole-dipole interaction opposed to a dipole-charge interaction shown in FIG. 2.

In other embodiments, the strength of the electric field can be regulated over time in order to control the interaction of the apparatus with particles of the medium. An appropriate electric field distribution in time and space can be determined using methods known in the art.

In other embodiments the objects may have a permanent dipole, such as is the case for water molecules. The dipole may also be magnetic, as in the case of the spin of an electron. A magnetic field can be used to align the particles of the medium with a desired direction. Such methods are well known in the art.

Note that the shape of a particle can also be modified within a first or second channel as a result of the polarization, for instance. A spherically symmetric particle in the first channel, when polarized along the axial direction, may assume an elongated shape with the long axis aligned with said axial direction. This can reduce the cross-sectional area of the particle viewed along the Y-axis compared to the reference scenario. Similarly, the long axis of such a polarized particle in the second channel may be aligned with the lateral axis. This can increase the cross-sectional area of the particle viewed along the Y-axis compared to the reference scenario. In other words, an alignment apparatus of an embodiment of the invention can be used to not only align an object to a desired cross-sectional geometry, but also to reshape or reconfigure an object to a desired cross-sectional geometry.

In some embodiments, the first alignment apparatus 960 may be configured in a similar manner as the second alignment apparatus 963, with the exception that the electric field in the vicinity of the first throat opening is perpendicular to the electric field in the vicinity of the second throat opening. The cross-section of the first alignment apparatus may thus also be square, with the collections of charge being arranged on opposing faces of the cubic first channel, with the characteristic normal of the rectangular plates of charge aligned with the Z-axis. In order to facilitate the passage of polarized particles with long axis parallel to the Z-axis from the first channel into the throat 956, the cross-sectional area of the throat may also be rectangular in this case, with a long axis parallel to the Z-axis, i.e. perpendicular to the electric field in the vicinity of the second throat opening. The dimension of the cross-section of the throat in the Z-direction may be equal to the same dimension of the cubic first and second channels.

In general terms, one can describe the purpose of the first and second alignment apparatuses to be the generation of a force field. A force field is a vector field which defines the magnitude and direction which an object of interest would experience at a specified location at a specified time. An “object of interest” is the object which the apparatus of the invention is intended to interact with in the aforementioned manner. For example, within a conductor, such as a metal, the free or conducting electrons may be objects of interest, while the lattice atoms, or the bound electrons and nuclei, are other objects of the medium surrounding the apparatus. Note that the force field can vary in time and space, and may also be a function of the properties of a specified object at the specified point in space and time. For example, in the case in which the forces of the force field arise from the interaction of a charged particle with a magnetic field, the force at a specified location and time is also a function of the velocity of said particle. In accordance with some embodiments of the invention, the force field of an alignment apparatus is configured to modify the orientation of an object, e.g. by rotating a vector property of an object, or to modify the magnitude of a vector property of an object, e.g. by stretching or polarizing an object, through the action of attraction or repulsion by a force field generating apparatus, in a manner in which the uniformity in the magnitude or orientation of a vector property of an object of a medium in time or space, in the case of a default boundary condition, is disturbed by an extent which exceeds any expected, microscopic fluctuations of said vector properties of objects of the medium. A vector property of an object is a property which can be described in the form of at least one vector, i.e. a property with a defined magnitude and direction. Examples of a vector property are a polarization axis, a magnetic dipole axis, a principal axis as defined by an inertia tensor, or a geometric long axis as defined by the geometric shape of an object. Note that an aforementioned force field may interact with or exert forces on an object in a manner in which moments or torques are acting about the center of mass of an object. The term “force field” therefore also encompasses any field which can be considered to be a torque or moment field. The force field may in some embodiments also be described or expressed in terms of a gradient of a potential field. Examples of repulsion are the electrostatic repulsion between like charges and the reflection of photons by a mirror, or particles by a surface. Examples of attraction are the gravitational force, the van der Waals force, the electrostatic attraction between unlike charges, or the magnetic attraction between magnetic dipoles. Note that these disturbances need not involve a change in the average energy of an object. In some embodiments, or some applications, the average energy of an object may change throughout an interaction, where the change nevertheless provides an improvement on the prior art, as measured by an objective function.

The term “medium” used herein describes any material which is capable of containing, carrying, transporting, or transferring an object of interest. A medium may be a gas, liquid, solid, or vacuum, for example. By default, a medium refers to the collection of all objects which interact with a specified apparatus. The term “object” used herein describes any component of a medium. An object may be described as a particle, such as a dust particle, a soot particle, a water droplet, or a water molecule. An object may have a property of interest, as well as a defining property, which may be used to distinguish an object from other objects of the medium. The invention applies to any medium which can be considered to comprise distinct objects. One can define a “default boundary condition” as a simplified scenario in which the properties of the medium at a first reservoir and a second reservoir are identical and uniform in time and space. The “baseline scenario” is a scenario in which the filtering apparatus in question is replaced by a “baseline apparatus”, defined as a solid, impenetrable, flat plate, and subjected to default boundary conditions. One can define a “baseline probability” as the probability for any object which interacts with a baseline apparatus to be located at a specified side of the baseline apparatus after the interaction is completed in a baseline scenario. In this case, the baseline probability is 50% for both sides of the baseline apparatus.

These artificial disturbances can be employed to increase or decrease a property of interest of objects of a specified defining property at a specified interface between a first and second reservoir, where the interface may be the throat facing side of the second throat opening, where the defining property may be the location of the object of interest in a first or second reservoir prior to interacting with an apparatus of the invention, where the property of interest may be the number of objects per unit volume, and where the increase or decrease is measured relative to the corresponding properties of the medium for a baseline scenario. In this particular type of embodiments of the invention, the defining property of an object is translated or imprinted on an object or a collection of objects by an alignment apparatus via the modification or disturbance of a filtered property of an object, such as the cross-sectional geometry of an object compared to the cross-sectional geometry of the throat when viewed along the Y-axis. A filtered property may be the magnitude or direction of a vector property of an object. A filtering apparatus, such as a throat with specified geometry surrounded by a reflective surface such as second surface 976, is configured to filter objects based on their filtered property, and by extension, their defining property. The filtering involves allowing the passage of objects with a specified set or range of filtered properties through the filtering apparatus, while reflecting a portion of objects outside of this set. By extension, therefore, a first alignment apparatus is configured to artificially increase the property of interest, i.e. density, of objects originating at a first reservoir at the second throat opening, where the density increase refers to a density which is, on average, larger than the density of objects of the medium in the first reservoir for the reference scenario. Alternatively, or concurrently, a second alignment apparatus may be configured to artificially decrease the density of objects originating at a second reservoir on the throat facing side of the second throat opening, where the density decrease refers to a density which is, on average, lower than the density of objects of the medium in the second reservoir for a reference scenario. As a result, there may be a net diffusion of a property of interest from a first reservoir 950 to a second reservoir 951.

The filtering apparatus can take several forms. For example, the filtering property may be the magnitude and orientation of a vector property of an object, such as the alignment of a permanent magnetic dipole of an object. In this example, the filtering apparatus may comprise a magnetic field, which is configured to reflect objects with a particular magnetic dipole orientation and allow the passage of objects with other permanent magnetic dipole orientations. Such a magnetic field can be generated by permanent magnetic dipoles embedded in the bulk material 966 in the vicinity of the second or first throat opening.

In the context of the simplified embodiment in FIG. 2, one can define an interaction between a particle and the depicted apparatus to commence when a particle passes through, intersects, or comes into contact with, planes containing the first surface 952 or the second surface 953, where the planes are parallel to the XZ-plane, and where the direction of travel prior to the interaction is in the opposite direction of the outward normal of the associated surface of the bulk material, which is directed in the positive Y-direction for the first surface 952, and the negative Y-direction for the second surface 953. These planes are denoted the first plane, and the second plane, respectively. An interaction can be defined to end when a particle no longer intersects or is in contact with the aforementioned planes. Said “contact” can in this case be defined as the existence of a non-negligible force between an object of the medium and an object of the apparatus, such as an object of bulk material 966.

One can define “input properties of interest” and “output properties of interest” as the properties of interest of a specified class of objects immediately before and immediately after interacting in a non-negligible manner with an embodiment of the invention, respectively. A property of interest may be the location of an object in either the first reservoir 950 or the second reservoir 951. The interaction of an object of interest with the apparatus of the invention can be described in terms of the difference between the input and output properties of interest. For example, an interaction can be described as either a transmission from the one reservoir to another reservoir, or a reflection back into the reservoir the object was located in before the interaction began. By definition, the type of interaction is a function of the “defining properties” of an object. The set of defining properties of the objects of interest may comprise the properties which distinguish the object of interest from other objects of the surrounding medium. In the embodiment shown in FIG. 2, the set of defining properties of an object also includes the input property of interest, i.e. the location of an object in either the first reservoir 950 or the second reservoir 951 immediately before interacting in a non-negligible manner with an embodiment of the invention. Throughout an interaction, an apparatus configured and operated in accordance with some embodiments of the invention will distinguish between or filter objects based on the value of the defining property of an object. In other words, the expected value of the type of interaction between a specified class of objects with at least one specified defining property and an embodiment of the invention is not equal to the expected value of the type of interaction of objects of the same specified class but different specified defining property. The expected value is the statistical expectation calculated for all objects contained within at least one specified class of objects which interact with an embodiment of the invention in a sufficiently long duration of time to provide a sufficiently accurate result. By default, a class of objects comprises all objects which interact with a specified apparatus.

In the context of this generation of embodiments, an embodiment of the invention is configured to align objects originating at a first reservoir 950 such that they may more readily pass through an alignment filter before they arrive at an interface to the second reservoir 951, such as the second throat opening, compared to a reference scenario. The alignment of objects is facilitated by a first alignment apparatus 960. In this way, the probability of an object arriving at the second throat opening to have originated at the first reservoir 950 is increased beyond the baseline probability of 50%.

The embodiment shown in FIG. 2 is also configured to align objects originating at a second reservoir 951 such that they may more readily be reflected by an alignment filter before they arrive at an interface to the first reservoir 950, such as the throat facing side of the second throat opening. The alignment of objects is facilitated by a second alignment apparatus 963, while the reflection is accomplished by a second inside surface 976. In this way, the probability of an object arriving at the throat facing side of the second throat opening to have originated at the second reservoir 951 is decreased below the baseline probability of 50%. As a result there may be a net diffusion of a property of interest from a first reservoir 950 to a second reservoir 951. In other embodiments, other such alignment and alignment filtering mechanisms may be used. There are a wide variety of such methods known in the art for any given application. Once the default boundary condition is removed, and the first and second reservoirs are assumed to be finite in size and otherwise isolated from each other and any other reservoirs, the concentration of objects of interest in the first reservoir could be reduced over time, while the concentration of objects in the second reservoir could be increased correspondingly. Embodiments of the invention can thus also be considered for applications involving pumping. Connecting several stages of the apparatus shown in FIG. 2 in series, i.e. allowing the second reservoir of a first apparatus to coincide with the first reservoir of a second apparatus, could achieve a desired steady-state concentration of objects of interest in a first reservoir 950.

In this particular embodiment, the aforementioned alignment is accomplished by the electric field of the first and second alignment apparatuses. Consider the trajectory 970 of particle 969, which has a non-zero velocity component in the negative Y-direction and is located in the first reservoir 950 preceding the interaction with the depicted apparatus. As the particle enters the electric field of a first alignment apparatus, such as first alignment apparatus 960, it is polarized and, due to a unique FPPA which is also parallel to the geometric long axis of the particle, aligned with the local electric field and the Y-axis in the first channel in the vicinity of the first throat opening. This sufficiently reduces the cross-section of the particle along the Y-direction and allows the particle to diffuse through the first throat opening into the throat, such as throat 956. Once inside the throat, the particle may continue to diffuse in the negative Y-direction, resulting in a passage through the second throat opening and through the second channel into the second reservoir 951. Note that the particle is temporarily aligned with the X-axis as is passes through the second channel due to the electric field produced by the second alignment apparatus 963. Trajectory 968 of particle 967 shows a similar interaction. Particle 971 has a non-zero velocity component in the positive Y-direction and is located in the second reservoir 951 preceding the interaction with the depicted apparatus. As indicated by trajectory 972, as particle 971 enters the electric field of the second alignment apparatus, it is polarized and aligned with the local electric field and the X-axis in the second channel in the vicinity of the second throat opening. This sufficiently increases the cross-section of the particle along the Y-direction and allows the particle to be reflected by the second inside surface, such as second inside surface 976, and return through the second channel and the second opening 955 into the second reservoir 951. Trajectory 974 of particle 973 shows a similar interaction. Note that some particles which originate at the first reservoir 950 will return to the first reservoir 950 once the interaction is complete. Similarly, some particles which originate at the second reservoir 951 will be found at the first reservoir 950 once the interaction is complete. This may occur for several reason. The intrinsic rotation of particles may not allow the alignment apparatuses to align all particles in the desired direction. On average, however, the apparatus is configured in such a manner, that there is a net diffusion of particles from the first reservoir 950 to the second reservoir 951 throughout an interaction for the default boundary condition.

One can define a first capture surface as the surface describing the first opening 954, and the second capture surface as the surface describing the second opening 955, where first and second capture surfaces are parallel to the XZ-plane. In this embodiment, the circular first capture area is smaller than the square second capture area. One can define a “first footprint surface” to be the total surface that forms an interface to the first reservoir 950 and is associated with an apparatus unit, i.e. the sum of the first capture surface and any portion of the first surface 952 associated with an apparatus unit. The boundary of the footprint surface of an apparatus unit is provided by the boundary of other footprint surfaces of adjacent apparatus units, where the apparatus units are, at least hypothetically, arranged periodically in the XZ-plane. For example, the boundary of a first footprint surface may have a hexagonal shape. Similarly, one can define a “second footprint surface” as the projection of the first footprint surface on the second surface 953. One can define a control volume which is bounded by the first footprint surface, the second footprint surface, as well as the surface parallel to the Y-axis connecting corresponding points of the first and second footprint surfaces of the control volume. For the default boundary condition, the probability of an object of the medium being located in the first reservoir 950 prior to interacting with the first or second footprint surface is 50%, with the other 50% applying to the second reservoir 951. Since the first capture area is smaller than the second capture area, the probability of a particle entering the channel system from the first reservoir 950 is smaller than the probability of a particle entering the channel system from the second reservoir 951. The fraction of particles which enter the channel system via the first opening 954 and exit via a second opening 955 is denoted the “first transmissivity”. The fraction of particles which enter the channel system via a second opening 955 and exit via a first opening 954 is denoted the “second transmissivity”. For the default boundary condition, there will be a net flow rate of objects from the first reservoir 950 to the second reservoir 951 when the net diffusivity is greater than one, where the net diffusivity is calculated by multiplying the ratio of the first and second transmissivity by the ratio of the first and second capture area. In the embodiment shown, the first alignment apparatus 960 and the second alignment apparatus 963 are configured to ensure that the ratio of the first transmissivity to the second transmissivity is larger than one and large enough to compensate for a ratio of the first capture area to the second capture area which is smaller than one, such that the net diffusivity is greater than one. The geometry of the channel system, the configuration of the alignment apparatuses, and the ratio of the first capture area to the second capture area are examples of parameters that can be optimized using methods known in the art in order to maximize an objective subject to constraints. The objective may be the net flow rate of a property of interest from the first reservoir 950 to the second reservoir 951.

The effectiveness of the depicted apparatus may be a function of the geometry and the scale, or the size, of the apparatus. The height of the depicted apparatus is defined to be the dimension of the apparatus along the Y-axis, i.e. the shortest distance between the first surface 952 and the second surface 953. It may be desirable to avoid excessive scattering amongst objects of interest, scattering between objects of interest and other objects of a medium, as well as any diffuse reflection by the walls within the channel system. Although such scattering behavior can be taken into account and, at least partially, compensated for in the configuration of the apparatus, it may degrade the intended performance of the apparatus, by reducing the first transmissivity or increasing the second transmissivity, for instance. In the absence of scattering, the initially necessarily negative Y-velocity component of a particle entering the channel system from the first reservoir 950, for example, is more likely to be maintained, which would enhance the first transmissivity. Scattering of objects of interest by other objects in the first or second channel may also affect or disrupt the alignment of the objects of interest and affect the first or second transmissivity. Diffuse reflection or scattering by the walls of the throat may also affect the probability of a particle entering the throat through the first throat opening also exiting the throat through the second throat opening. Other types of scattering may also apply to other embodiments of the invention.

There are several approaches for reducing such scattering. For example, any reflective surfaces of an apparatus can be constructed in a manner which avoids or reduces diffuse reflections. An apparatus can also be configured to reduce the expected number of reflections of objects by any reflective surfaces of an apparatus in order to reduce any reductions in transmissivity associated with diffuse reflections. The apparatus may also be configured to be of a small size in order to minimize the probability of scattering between objects of interest and other objects of a medium by reducing the expected number of these objects being present in a channel system at an instant in time. In some embodiments it may also be possible to artificially exclude, filter, or remove such other objects of the medium from a channel system, while allowing a sufficient portion of objects of interest to interact with the channel system as intended. To maintain a high first transmissivity despite scattering amongst objects of interest, it may be desirable for the height of the apparatus to be smaller than a length and several orders of magnitude larger than the mean free path of an object of interest in the medium for a default boundary condition, for example. In some embodiments, it may even be preferable for the height of the apparatus to be a fraction of the mean free path, where a fraction means less than one. The characteristic width of a channel, such as the diameter of the first channel is subject to similar considerations. The width of the first channel may also be within several orders of magnitude of the mean free path of an object of interest in the medium, for example. The width may also be a fraction of the mean free path, depending on the application and the properties of the medium. Note that there may be more than one throat channel connecting a first channel to a second channel. Note that in some cases, it may be possible and desirable to configure a medium in a way in which the objects of interest have a suitable mean free path length. For instance, the density of a medium in the first and second reservoir may be regulated or modified to a suitable value. Amongst other factors, suitability may be determined by the relation between the tolerances of a specified manufacturing method and the required size and shape resolution of an apparatus of the invention. The appropriate material, geometry, and method of manufacture can be found by those skilled in the art. Note that such size considerations apply to all embodiments of the invention, even though they may have a negligible effect for some applications.

The manner in which a filtration apparatus is manufactured depends on the scale or the characteristic length of a filtration apparatus. For example, consider an application example in which the mean free path of objects of interest in a medium is about one millimeter. The characteristic length of an example embodiment of a filter system for such an application may be about one centimeter. Structures of this scale can be readily manufactured and mass produced using conventional mechanical manufacturing techniques, such as computer numerical controlled (CNC) mills, selective laser sintering (SLS), photolithography and etching, additive printing processes, and so on.

Embodiments of a filter apparatus for which the characteristic length is on the order of nanometers can be manufactured with semiconductor manufacturing equipment and procedures. For example, grayscale electron beam or ion beam lithography can be employed to manufacture molds with large arrays of repeating patterns of complex geometry at the nanometer scale. These molds can be employed to imprint the desired surface features on a substrate using nanoimprint lithography. This method can be employed to manufacture the channels shown in the examples of FIG. 1 and FIG. 2, for example. In another example, filtration apparatuses can be manufactured using nanometer scale additive manufacturing techniques, such as electron beam induced deposition. These techniques can be used to manufacture nanoscale conductors, wires, and charge collections, such as those shown in FIG. 1 and FIG. 2. Conventional microchip manufacturing techniques can be employed to manufacture three-dimensional structures, such as the channels and the collections of charge and associated circuits contained within the bulk material. Since a filtering apparatus will typically comprise an array of a large number of identically configured channels systems, these and other manufacturing techniques can benefit from interference effects to manufacture the aforementioned large arrays of complex structures. These methods are known in the field of interference lithography, for example. Subtractive manufacturing techniques such as deep reactive ion etching can be employed to manufacture channels, such as throat 956, for example. The channel diameter can be on the order of tens of nanometers, for instance.

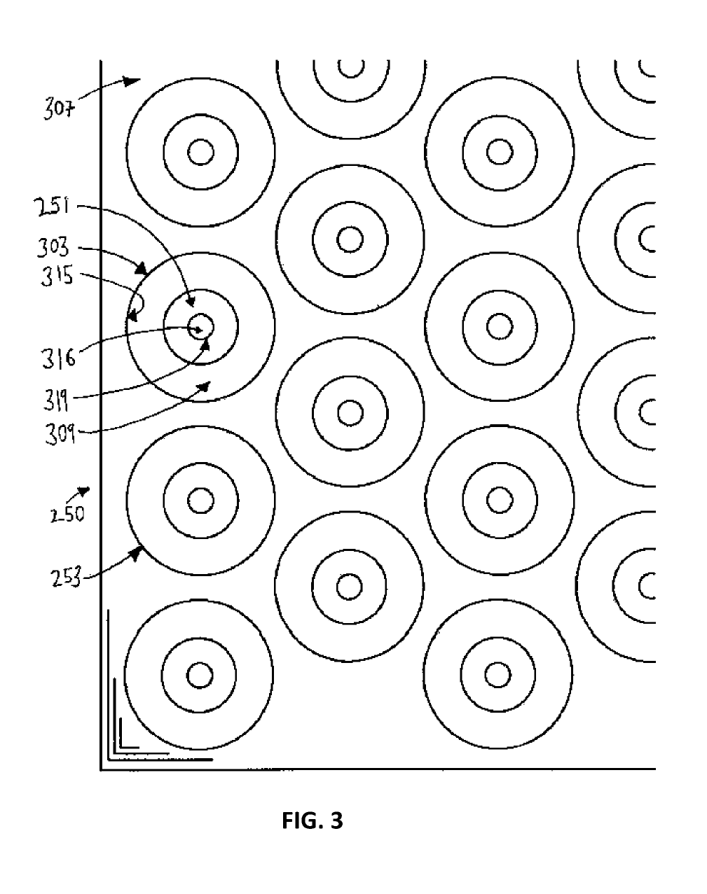

FIG. 3 shows a top view of an embodiment configured in a similar manner as the embodiment shown in FIG. 1.

FIG. 3 shows the first surface 307, inside apparatus 316, the inner surface 319 of the inside apparatus 316, the outline of first opening 303, and first inside surface 309, amongst other features of the embodiment shown in FIG. 1. Channels configured in a similar manner as the channel system shown in FIG. 1, are arranged in an array on a filtering plate 250, as indicated by first opening 303 and first opening 253 of an adjacent channel.

Objects of interest approaching the filtering apparatus 250 are able to pass through channel 251 or throat 304 to the second reservoir on the other side of the plate or the filtering apparatus 250.

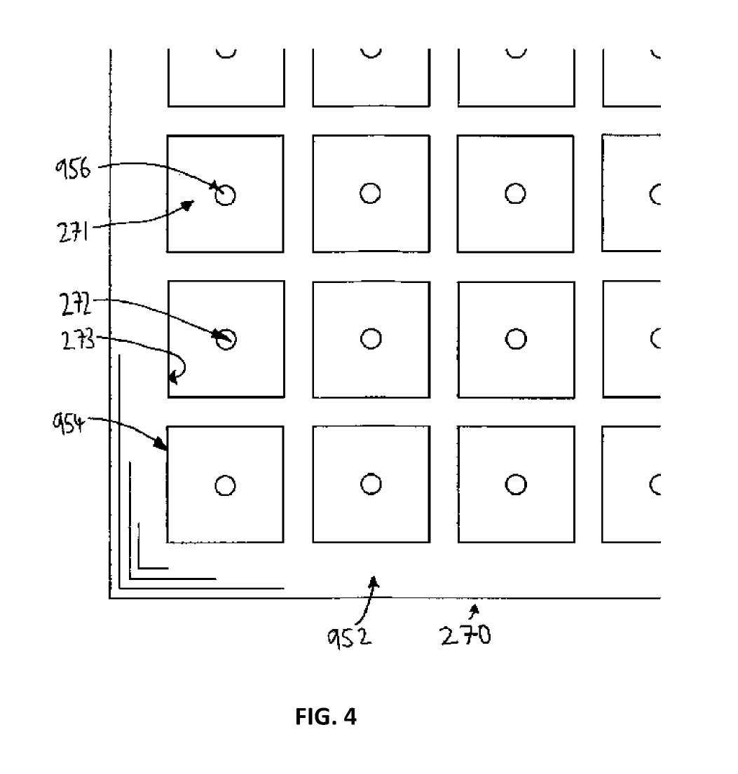

FIG. 4 shows a top view of an embodiment configured in a similar manner as the embodiment shown in FIG. 2.

FIG. 4 shows the first surface 952, throat 956, the outline of first opening 954, an adjacent throat 272, and a first inside surface 271 of a first channel opening, which is configured in a similar manner as first inside surface 309 in FIG. 1, an interior wall surface of a first channel opening 273 amongst other features of the embodiment shown in FIG. 2. Channels configured in a similar manner as the channel system shown in FIG. 2, are arranged in an array on a filtering plate 270. The throat, such as throat 956, is circular in cross-section, while first channel opening, such as first channel opening 954 is square in cross-section in this particular embodiment. In other embodiments, first channel opening 954 can be circular, rectangular, hexagonal, or polygonal, for example.

Objects of interest approaching the filtering apparatus 270 are able to pass through throat 956 or throat 272 to the second reservoir on the other side of the plate or the filtering apparatus 270.

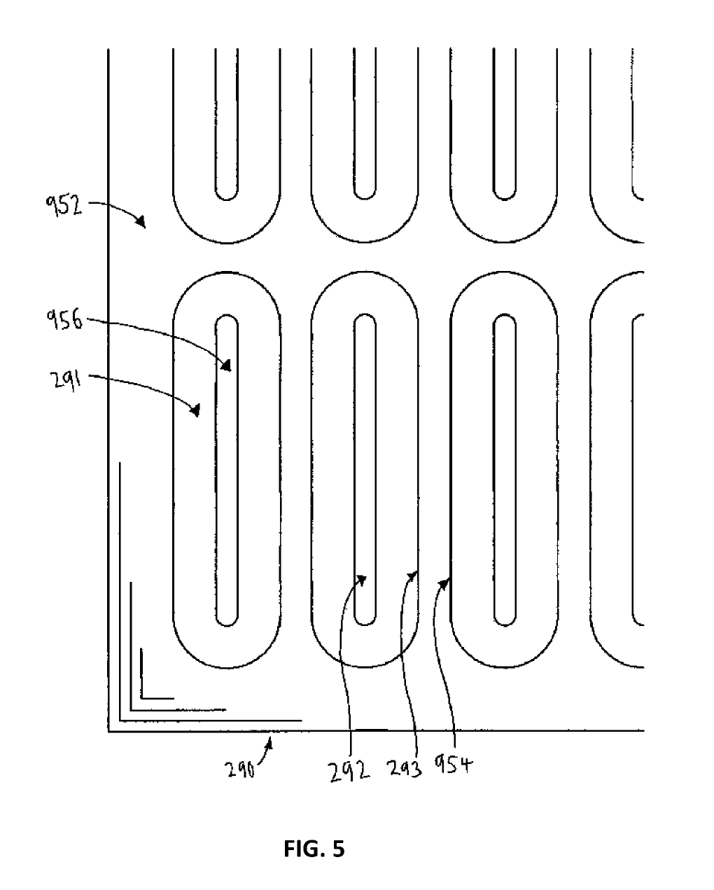

FIG. 5 shows a top view of another embodiment configured in a similar manner as the embodiment shown in FIG. 2.

FIG. 5 shows the first surface 952, throat 956, the outline of first opening 954, an adjacent throat 292, and a first inside surface 291 of a first channel opening, which is configured in a similar manner as first inside surface 309 in FIG. 1, and an interior wall surface 293 of a first channel opening, amongst other features of the embodiment shown in FIG. 2. Channels configured in a similar manner as the channel system shown in FIG. 2, are arranged in an array on a filtering plate 290, as indicated by throat 292 being located adjacent to throat 956. The throat, such as throat 956, is rectangular in cross-section, while first channel opening, such as first channel opening 954 is also rectangular in cross-section, where the short sides of the rectangular cross-sections are semi-circular.

Objects of interest approaching the filtering apparatus 290 are able to pass through throat 956 or throat 292 to the second reservoir on the other side of the plate or the filtering apparatus 290.

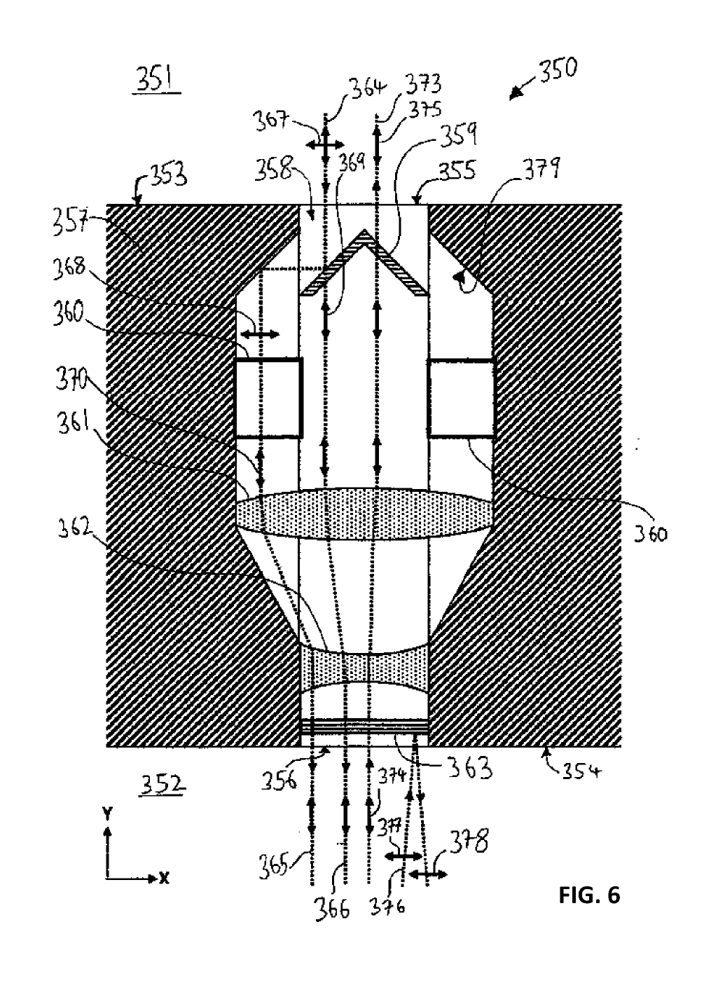

FIG. 6 shows a cross-sectional view of an embodiment configured to interact with polarized objects of interest. The objects of interest can be photons or electrons, for example. Note that electrons can be considered to behave like waves, as described by quantum mechanics. The polarization of an electron can refer to the orientation of the axis of spin of an electron.

There is a first reservoir 351, and a second reservoir 352. A filtering apparatus 350 comprises a first surface 353 and a second surface 354. A channel 358 allows objects of interest to pass from the first reservoir 351 through a first opening 355 and a second opening 356 through the filtering apparatus to the second reservoir 352. The interior surface 379 of bulk material 357 is configured to be reflective to objects of interest.

Objects of interest entering channel 358 from the first reservoir 351 or from the second reservoir 352 are not polarized on average. The polarization of objects of interest immediately prior to interacting with the filtering apparatus 350 is denoted the “initial polarization”. An interaction can be considered to commence at the beginning of a reflection from the first surface 353 or the second surface 354, or the entering into channel 358 by crossing the XZ-plane at the first opening 355 or the second opening 356. An interaction can be considered to terminate at the completion of a reflection from the first surface 353 or the second surface 354, or the exiting out of channel 358 by crossing the XZ-plane at the first opening 355 or the second opening 356. The first initial polarization is the initial polarization of objects of interest located in the first reservoir 351 immediately prior to interacting with the filtering apparatus 350. The second initial polarization is the initial polarization of objects of interest located in the second reservoir 352 immediately prior to interacting with the filtering apparatus 350.

The average intensity, or the flux of objects of interest, i.e. the number of objects of interest per unit time and per unit area, incident on the filtering apparatus from the first reservoir 351 is denoted the “first incident flux”. The average flux incident on the filtering apparatus from the second reservoir 352 is denoted the “second incident flux”. For a dynamic boundary condition, the first incident flux and the second incident flux are equal in magnitude and uniformly distributed along the XZ-plane at the first surface 353 and the XZ-plane at the second surface 354. For a static boundary condition, the second incident flux is larger than the first incident flux. In other embodiments or applications, the first incident flux can be larger than the second incident flux.

In this embodiment, the first and second initial polarization of objects of interest is uniformly distributed over all possible angles of polarization. In other words, the objects of interest which interact with the filtering apparatus 350 are not polarized on average prior to interacting with the filtering apparatus 350 from the first reservoir 351 or the second reservoir 352. Objects of interest can be photons emitted as thermal radiation from a thermal source, for example. Upon entering the channel, the objects of interest encounter a polarizing beam splitter configured to separate the beams into horizontally polarized components 368 and vertically polarized components 369, for example. In this case, the beam splitter is configured to reflect horizontally polarized objects and transmit vertically polarized objects. The beam splitter can comprise several horizontally arranged conducting strips at subwavelength separations relative to each other, where the wavelength refers to the wavelength of the objects of interest. The strips can also be configured to be as thin as possible, for example. In the depicted embodiment, vertically polarized photon components are allowed to pass through, while horizontally polarized photon components are reflected by the interior surface 379 of the bulk material of the filtering apparatus and directed towards the alignment apparatus 360.

In other embodiments, other optical apparatuses can be employed to accomplish said polarizing beam splitting. For example, prisms such as Wollaston prisms, Rochon prisms, Senarmont prisms, or Glan-Taylor prisms can be employed. Such prisms can comprise birefringent materials, such as calcite, for instance. In other embodiments, polarizing beam splitters can employ Fresnel reflection, for example.

In general, the purpose of the polarizing beam splitter is to separate objects of interest entering channel 358 from the first reservoir 351 into, on average, differently polarized components. Note that the difference in polarization can be a difference in the average orientation of the polarization axis by a value greater than zero degrees, where the average is calculated over all objects of interest exiting the polarizing beam splitter in one of at least two specified directions, and where the difference is the difference in the average orientation between at least two specified directions. By default, the first direction is the direction of objects of interest which, after exiting or completing an interaction with a polarizing beam splitter, such as polarizing beam splitter 359, are incident on, or enter, an alignment apparatus, such as alignment apparatus 360. By default, the second direction is the direction of objects of interest which, after interacting with a polarizing beam splitter, such as polarizing beam splitter 359, are not incident on, and do not enter an alignment apparatus, such as alignment apparatus 360.

In the alignment apparatus 360, the polarization of the horizontally polarized components, such as horizontally polarized object 368, can be modified or rotated to align with the vertically polarized components, as indicated by the rotation or conversion of horizontally polarized object 368 into vertically polarized object 370. The polarization plane can be rotated using liquid crystals or faraday rotators, for example. In a faraday rotator, a magnetic field is employed to rotate the axis of polarization of an object. In a liquid crystal, the helical alignment of electric dipoles within the crystal rotates the axis of polarization of an electromagnetic wave passing through the crystal. The liquid crystals can be configured in a similar manner as the liquid crystals found in conventional liquid crystal displays (LCDs), for instance. In LCDs there is typically a polarizer located above and below a liquid crystal. For the embodiment shown in FIG. 6, in alignment apparatus 360, there are no such polarizers. In other embodiments, there can be reflective polarizers, i.e. polarizing beam splitters, of a similar architecture as polarizing beam splitter 362. For example, there can be a polarizing beam splitter located on the side of alignment apparatus 360 facing the first reservoir 351. This polarizing beam splitter can be configured to allow horizontally polarized objects to pass through. For instance, the slots between thin electrically conducting strips within the polarizing beam splitter or reflector can be arranged vertically. In continuation of this example, there can be a polarizing beam splitter located on the side of alignment apparatus 360 facing the second reservoir 352. This polarizing beam splitter can be configured to allow vertically polarized objects to pass through. For instance, the slots between thin electrically conducting strips within the polarizing beam splitter or reflector can be arranged horizontally. The polarization axis of an object of interest which passes through an alignment apparatus, such as alignment apparatus 360, can be rotated 90 degrees, or 270 degrees, or 450 degrees, for example.

Subsequently, both the originally vertically polarized objects, such as object 369, and the newly vertically polarized objects, such as object 370, are focused by a converging lens 361 and diverging lens 362 onto a second polarizing beam splitter 363 configured to allow vertically polarized objects through, as indicated by trajectory 366, 365, and 373, while reflecting horizontally polarized objects, such as object 377, as indicated by trajectory 376, and as indicated by location and polarization 378 at a later point in time. Note that trajectory 373 of object 374 is directed from the second reservoir 352 into first reservoir 351, with location and polarization 375 in the first reservoir 351 shown at a later point in time.

The principle of operation of the embodiment shown in FIG. 6 will be explained for the following simplified and idealized scenario. The first incident flux and the second incident flux are equal in magnitude and distributed uniformly in space. The direction of motion of objects of interest prior to interacting with the filtering apparatus 350, denoted the “initial direction”, is parallel to the Y-axis in this simplified scenario. In other embodiments, the initial direction can be any direction. The first and second initial polarizations are uniformly distributed over the range of all possible polarizations, as indicated by object 367. The objects of interest are photons in this example. In this idealized scenario, 50% of the flux of objects of interest incident on first channel opening 355 from the first reservoir 351, is transmitted through polarizing beam splitter 359, through the focusing apparatus comprising the converging lens 361 and the diverging lens 362, and through the second polarizing beam splitter 363 into the second reservoir 352. The remaining 50% of the flux of objects of interest incident on first channel opening 355 from the first reservoir 351 is reflected by polarizing beam splitter 359, and subsequently reflected by interior surface 379, and transmitted through the alignment apparatus 360, transmitted through the focusing apparatus comprising the converging lens 361 and the diverging lens 362, and through the second polarizing beam splitter 363 into the second reservoir 352, as indicated by trajectories 364, 365, and 366. As a result, the first transmissivity is 100% or unity in this scenario.

Similarly, 50% of the flux of objects of interest incident on second channel opening 356 from the second reservoir 352 is transmitted through polarizing beam splitter 363 and through the focusing apparatus comprising the diverging lens 362. Half of this flux, i.e. 25% of the second incident flux on second channel opening 356, passes through polarizing beam splitter 359 into the first reservoir 352. The other half of this flux, i.e. 25% of the second incident flux incident on second channel opening 356, passes through alignment apparatus 360 in the positive Y-direction where the polarization direction is changed, is subsequently reflected by interior surface 379 and by polarizing beam splitter 359, and subsequently transmitted into the first reservoir 351. Therefore, 50% of the second incident flux incident on second channel opening 356 is transmitted from the second reservoir 352 to the first reservoir 351. The remaining 50% of the second incident flux incident on second channel opening 356 is reflected back into the second reservoir 352. As a result, the second transmissivity is 50% in this scenario, which is smaller than the aforementioned first transmissivity of 100%.

A larger fraction of objects which enter channel 358 from the first reservoir 351 are therefore transmitted to the second reservoir 352 compared to the fraction of objects which enter channel 358 from the second reservoir 352 and are transmitted to the first reservoir 351. This results in a net diffusion or a net flux of objects from the first reservoir 351 to the second reservoir for a dynamic boundary condition, or a larger concentration of objects in the second reservoir 352 compared to the first reservoir 351 for a static boundary condition.

As mentioned, several filtering apparatuses 350 can be arranged in series and in parallel to enhance the magnitude of said net diffusion or said difference in concentration.

Note that, in other embodiments and other applications, there can be a difference in the average first initial polarization and the average second initial polarization. In such configurations, the orientation of the transmitting polarizing axis of second polarizing beam splitter 363 can be configured in a manner which minimizes the second transmissivity, i.e. the probability of transmission, of objects of interest from the second reservoir 352 through second polarizing beam splitter 363. Similarly, the orientation of the transmitting polarizing axis of polarizing beam splitter 359 as well as the change in the orientation of a polarizing axis throughout alignment apparatus 360, can be configured in a manner which maximizes the first transmissivity of an object of interest from the first reservoir 351 into the second reservoir 352.

The focusing apparatus of the embodiment shown in FIG. 6 comprises a converging lens 361 and a diverging lens 362. In this particular example, the converging lens 361 is a double convex lens, and the diverging lens 362 is a double concave lens. In other embodiments, the lenses can be planar convex or planar concave lenses, for example. The materials of these lenses are configured to have an index of refraction which is larger than the index of refraction in the medium surrounding the lenses. The medium surrounding the lenses can be air, a low pressure gas, or a vacuum, for example, and the material of the lenses can be glass, or polycarbonate, for example. Note that the materials of the lenses should be configured in a manner in which the objects of interest, such as photons, are able to pass through, and to be refracted by, the lenses. In other words, the reflectivity of the lenses at the range of frequencies of the objects of interest should be sufficiently small that a sufficient flux of objects of interest is able to pass through the channel 358. This is particularly relevant for a dynamic boundary condition, where the magnitude of the net flux from the first reservoir 351 to the second reservoir 352 can be a performance metric. Note that a large portion of thermal radiation emitted by a material at room temperature is in the infrared spectrum, and note that some refractive materials, such as glass, are reflective to at least a portion of photons in the infrared spectrum. In such cases, other materials such as polycarbonate can be used, for example. Alternatively or concurrently, the refractive materials can be coated in an anti-reflective coating in order to reduce the reflectivity of such optical instruments to objects of interest.

In other embodiments, the focusing apparatus can comprise convex and/or concave surfaces configured to focus trajectories of objects of interest. These surfaces can be configured in a similar manner as the mirrors of a telescope or solar concentrator, for example. In such embodiments, the surfaces are configured in a similar manner as surface 379 in the sense that the surfaces have a reflectivity relative to the objects of interest which is greater than zero within at least a portion of the range of frequencies of the objects of interest. For example, the surfaces, including interior surface 379, first surface 353, and second surface 354, can be coated in a reflective material, such as a metal such as silver or aluminium, in order to enhance the reflectivity of these surfaces with respect to the objects of interest. In other embodiments, a focusing apparatus can comprise metamaterial lenses. In other embodiments, a focusing apparatus can comprise diffraction lenses, such as Fresnel zone plates.

In the case in which the objects of interest are electrons, bulk material 357 can be an electrical insulator, and the medium in the first reservoir 351, the channel 358, and the second reservoir 352 can be an electrical conductor, such as copper. In the case in which the focusing apparatus comprises lenses, as shown in FIG. 6, the material in the lenses can be configured to have a refractive index which is larger than the refractive index of the medium with respect to electrons. In other embodiments, the refractive index of the lenses can be lower than the refractive index of the medium. In such embodiments, the converging lens 361 is a concave lens instead of a convex lens shown in FIG. 6, and diverging lens 362 is a convex lens instead of a concave lens shown in FIG. 6.

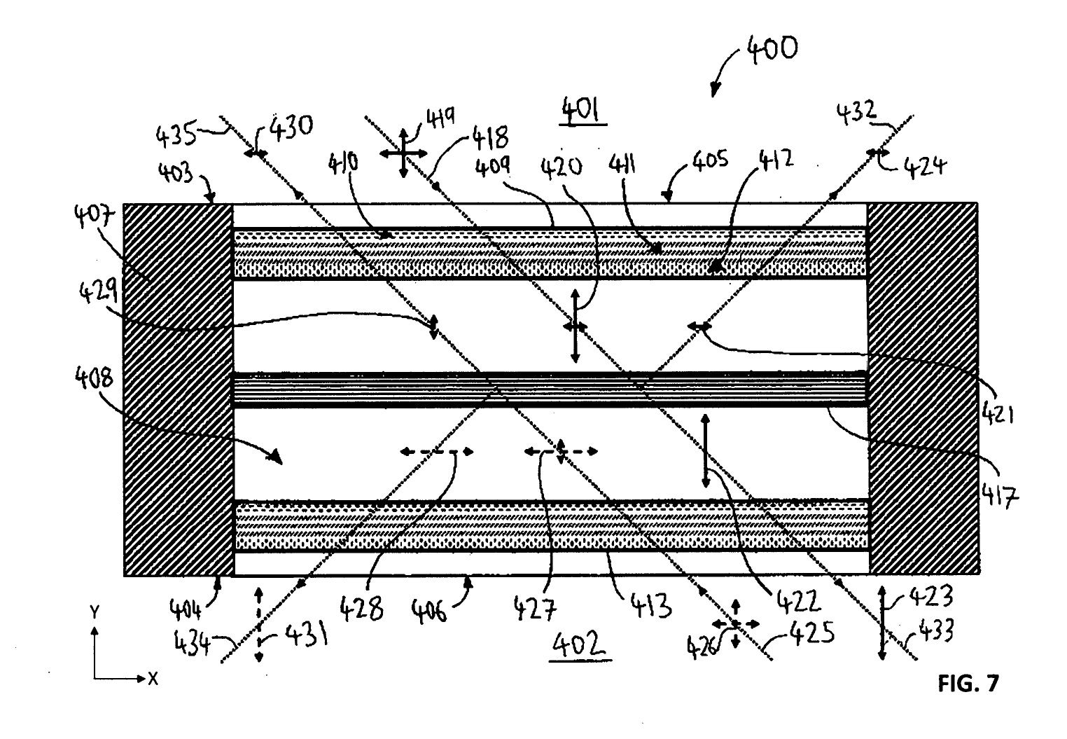

FIG. 7 shows a cross-sectional view of an embodiment configured to interact with polarized objects of interest. The objects of interest can be photons or electrons, for example.

There is a first reservoir 401, and a second reservoir 402. A filtering apparatus 400 comprises a first surface 403 and a second surface 404. A channel 408 allows objects of interest to pass from the first reservoir 401 through a first opening 405 and a second opening 406 through the filtering apparatus to the second reservoir 402. Bulk material 407 is configured to be at least partially reflective to objects of interest, with a reflectivity greater than zero for at least a portion of objects of interest.

Filtering apparatus 400 comprises a first alignment apparatus 409 configured to align the polarization of at least a portion of horizontally polarized objects moving from the first reservoir 401, i.e. in the negative Y-direction, through the first alignment apparatus 409, with the vertical axis, i.e. the Z-axis. In other words, the direction of polarization of at least a fraction of the horizontally polarized components of objects is modified, altered, rotated, or reoriented towards the vertical polarization direction for objects of interest moving in the negative Y-direction through the alignment apparatus 409.

First alignment apparatus 409 is also configured to allow at least a portion of initially vertically polarized objects to pass through the first alignment apparatus 409 in the negative Y-direction unaltered, i.e. without a change to the direction of polarization. In other words, transmissivity of vertically polarized objects in the negative Y-direction is greater than zero, where the transmissivity refers to the fraction of vertically polarized objects which enter first alignment apparatus 409 from the first reservoir 401, and which also exit the first alignment apparatus 409 in a state of vertical polarization. In the idealized embodiment shown in FIG. 7, the value of this transmissivity is unity. In other embodiments, the value of this transmissivity is greater than zero.

An alignment apparatus with the aforementioned features can be a liquid crystal, for example. For instance, on the side of the liquid crystal facing the first reservoir 401 the alignment of the crystals can correspond to the horizontal alignment of the horizontal polarization. The crystals can be aligned substantially parallel to the X-axis, for example. This can be accomplished by slots, grooves, or scratches on the interior surface of a glass or polycarbonate plate containing the liquid crystals in the positive Y-direction, where the plate is arranged parallel to the XZ-plane. On the side of the liquid crystal facing the second reservoir 402 the alignment of the crystals can correspond to the vertical alignment of the vertical polarization. The crystals can be aligned substantially parallel to the Z-axis, for example. As before, this can be accomplished by slots on the interior surface of a glass or polycarbonate plate containing the liquid crystals in the negative Y-direction, where the plate is also arranged parallel to the XZ-plane. In between these two surfaces or sides of the liquid crystal, the orientation of the electric dipoles, i.e. the crystal molecules, can change gradually. The crystals are thus arranged in a helical pattern, similar to the helical pattern of DNA molecules. At any cross-sectional XZ-plane within alignment apparatus 409, therefore, the long axis or the polarization axis of a substantial fraction of electric dipoles, i.e. of the crystal molecules, lies approximately in the XZ-plane, and the angle of said axis relative to the X-axis changes gradually in the negative Y-direction from approximately 0 degrees at the surface facing the first reservoir 401, to approximately 90 degrees, or 270 degrees, or 450 degrees at the surface facing the second reservoir 402, throughout alignment apparatus 409. The orientation of the dipoles within the alignment apparatus in a cross-sectional view along the Y-direction, i.e. in the XZ-plane, is indicated schematically by horizontal dashed lines 410, angled dashed lines 411, and vertical dashed lines 412. Note that the orientation of these dashed lines does not correspond to the orientation of the dipoles in the cross-sectional view shown in FIG. 7, i.e. in the view along the Z-direction, or in the XY-plane, but instead corresponds to the orientation of the dipoles in the cross-sectional view in the Y-direction, i.e. in the XZ-plane, i.e. in the direction of horizontal polarization, i.e. along the X-direction, or vertical polarization, i.e. along the Z-direction. In other words, for clarity, the component of the long axis or the polarization axis of dipoles or crystals in the Z-direction is shown schematically as a component along the Y-direction in FIG. 7.

Thus the electric dipoles act as waveguides for horizontally polarized objects, i.e. objects polarized along the X-direction, entering the alignment apparatus 409 from the first reservoir 401, where the waveguides change the direction of polarization to the vertical axis, i.e. towards a polarization along the Z-direction, throughout the alignment apparatus 409. Due to the spacing between the individual crystals or electric dipoles in a cross-sectional XZ-plane, the vertically polarized objects entering the alignment apparatus 409 from the first reservoir 401 and moving through the alignment apparatus 409 do not experience a change in the orientation of their axis of polarization in a simplified, idealized scenario.

In other embodiments, other optical instruments, or other suitable polarizable electric dipoles, can be employed to perform the purpose of this waveguide. For example, an alignment apparatus can comprise several artificial dipoles arranged in a similar manner as the liquid crystals in the aforementioned description. The artificial dipoles can be short conducting strips, for example, where the separation and the length of the strips is of the same order of magnitude as the length of the crystal molecules along their long axis.

As a result of the aforementioned configuration of alignment apparatus 409, the objects which pass through the alignment apparatus 409 from the first reservoir 401 are primarily polarized along the vertical direction 420.

A polarizing beam splitter 417 is configured to allow all vertically polarized components to pass through the polarizer 417, while reflecting all horizontally polarized components. In other embodiments, polarizing beam splitter 417 is configured to allow all a larger percentage of vertically polarized components to pass through the polarizer 417 compared to the percentage of horizontally polarized components. In other words, the transmissivity of vertically polarized components through polarizing beam splitter 417 is greater than the transmissivity of horizontally polarized components, where transmissivity refers to the portion of objects of interest for which the specified polarization is unchanged.

Note that, in other embodiments, the first alignment apparatus 409 is mounted flush with polarizing beam splitter 417, i.e. there is no gap between the surface of first alignment apparatus 409 facing in the negative Y-direction, towards second reservoir 402, and the surface of polarizing beam splitter 417 facing in the positive Y-direction, towards first reservoir 401. In such embodiments, the second alignment apparatus 413 is mounted flush with polarizing beam splitter 417, i.e. there is no gap between the surface of second alignment apparatus 413 facing in the positive Y-direction, towards first reservoir 401, and the surface of polarizing beam splitter 417 facing in the negative Y-direction, towards second reservoir 402. The characteristic dimension of filtering apparatus 400 in such configurations is the extent of first alignment apparatus 409, polarizing beam splitter 417, and second alignment apparatus 413, combined, along the Y-direction. In general, the characteristic dimension of embodiments configured in a similar manner as embodiment 400 is the shortest distance between the surface of alignment apparatus 409 facing the first reservoir 401, and the surface of alignment apparatus 413 facing the second reservoir 402. In order to minimize the characteristic dimension, therefore, it is desirable to minimize or avoid any gaps between the alignment apparatuses and polarizing beam splitter 417. In typical embodiments, this characteristic dimension is smaller than 1000 times the mean free path of objects of interest in an adjacent reservoir, such as first reservoir 401, or second reservoir 402. In some embodiments, this dimension is smaller than 10 mean free paths of objects of interest, for example. In some embodiments, this dimension is smaller than one mean free path of objects of interest, for example. As mentioned, the objects of interest can be photons, electrons, or other object which can be considered to exhibit properties of interest, as described in the context of all of the other embodiments described herein, such as density, charge, or a vector property of interest, such as an axis of polarization. Other examples of such objects are virtual photons, virtual electrons, or virtual positrons, as described by quantum field theory. For example, object 327 and object 973 can be a virtual electric dipole, object 377 or object 426 can be a virtual photon or virtual electron, and object 477 can be a virtual electron, and, in the corresponding embodiment in which object 477 is positively charged, object 477 can be a virtual positron, for example. Note that the mean free path of virtual photons is within several orders of magnitude of one nanometer. An annihilation event of a virtual object, such as a virtual electron and a virtual positron, can be considered to be a scattering event, the distance travelled between which determines the mean free path of a virtual object. The characteristic length of filtration apparatuses, such as filtration apparatus 400, or a filtration apparatus shown in the other figures, configured to interact with virtual photons can be less than 1 micrometer, for example. The characteristic length of such filtration apparatuses can be less than 100 nanometers in another example. The characteristic length of such filtration apparatuses can be less than 10 nanometers in another example. Note that the characteristic length is as small as possible in the preferred embodiment. The characteristic length, the size, or the height of a filtering apparatus can be limited by the thickness of atoms or molecules used in the manufacture of a filtering apparatus, as well as by manufacturing methods. Embodiments of the invention configured to interact with virtual particles can be employed to generate a net diffusion or a bulk flow of virtual particles for a dynamic boundary condition. Such a bulk flow is associated with the production of thrust, or an axial pressure, which can act on the filtering apparatus in the positive Y-direction, for instance. Note that such thrust can be generated in a vacuum, such as the vacuum of space. Said thrust can be employed to do mechanical work, such as accelerate a mass such as a spacecraft, or generate torque on a drive shaft. Such a drive shaft can be mechanically coupled to an electric generator, for example. The electric generator can thus convert the mechanical power into electrical power. The power is provided by the reduction of the self-energy or the thermal energy of the objects of interest. In the case of virtual objects of interest, this energy is also known as the zero point energy. In a static boundary condition, a larger density, pressure, or concentration of objects of interest can be generated in a second reservoir compared to a first reservoir.

The characteristic length of the filtering apparatus is a function of the mean free path or the mean free time of objects of interest which interact with the filtering apparatus. Scattering events can lead to a change in the orientation of a polarization axis as well as a change in the direction of motion of an object of interest, for example. Scattering events within the characteristic dimension of a filtering apparatus can be detrimental to the performance of a filtering apparatus, where the performance can be the net diffusion of objects of interest for a dynamic boundary condition, or the difference in pressure, density, or concentration of objects of interest for a static boundary condition.

Filtering apparatus 400 also comprises a second alignment apparatus 413, which is configured in similar manner as alignment apparatus 409. Alignment apparatus 413 can be considered to be identical to alignment apparatus 409, but offset in the negative Y-direction to the location of alignment apparatus 413 shown in FIG. 7.

In other words, alignment apparatus 413 is configured to align the polarization of at least a portion of vertically polarized objects moving from the second reservoir 402, i.e. in the positive Y-direction, through the second alignment apparatus 413, with the horizontal axis, i.e. the X-axis. In other words, the direction of polarization of at least a fraction of the vertically polarized components of objects is modified, altered, rotated, or reoriented towards the horizontal polarization direction for objects of interest moving in the positive Y-direction through the alignment apparatus 413.

Second alignment apparatus 413 is also configured to allow at least a portion of initially horizontally polarized objects to pass through the second alignment apparatus 413 in the positive Y-direction unaltered, i.e. without a change to the direction of polarization. In other words, transmissivity of horizontally polarized objects in the positive Y-direction is greater than zero, where the transmissivity refers to the fraction of horizontally polarized objects which enter second alignment apparatus 413 from the second reservoir 402, and which also exit the second alignment apparatus 413 in a state of horizontal polarization. In the idealized embodiment shown in FIG. 7, the value of this transmissivity is unity. In other embodiments, the value of this transmissivity is greater than zero.

The principle of operation of the embodiment shown in FIG. 6 will be explained for the following simplified and idealized scenario. As described in the context of FIG. 6, the first incident flux and the second incident flux are equal in magnitude and distributed uniformly in space, as is the case for a dynamic boundary condition. The first and second initial polarizations are uniformly distributed over the range of all possible polarizations, as indicated by object 419 or object 426. The objects of interest are photons in this example. FIG. 7 shows several example trajectories, such as trajectory 418 and trajectory 425, of objects of interest interacting with filtering apparatus 400 in this simplified scenario.

Trajectory 418 shows the trajectory of an object of interest which is located in the first reservoir 401 immediately prior to interacting with filtering apparatus 401. The object is initially not polarized on average, as indicated by polarization 419, which indicates an equal magnitude of polarization components in the horizontal direction, along the X-direction, and in the vertical direction, along the Z-direction. For clarity, the polarization component of an object along the Z-direction is shown schematically as a double arrow, such as double arrow 422, along the Y-direction in FIG. 7. After having passed through first alignment apparatus 409 in the negative Y-direction, at least a portion of the horizontal polarization components of the object have been aligned with the vertical polarization axis, as shown by polarization 420. In the idealized embodiment, the transmissivity of objects through alignment apparatus 409 is unity. In other words, there is no reduction in the flux of objects of interest throughout alignment apparatus 409. In other embodiments, the transmissivity can be any number greater than zero and smaller than, or equal to, unity. The initially non-polarized objects of interest are primarily vertically polarized after having passed through alignment apparatus 409 in the negative Y-direction.

The horizontally polarized components of object 420 are reflected by polarizing beam splitter 417, as indicated by trajectory 432 and object 421 and object 424. Recall that alignment apparatus 409 and 413 are configured identically in this embodiment. Further recall that alignment apparatus 413 is configured to allow at least a portion of initially horizontally polarized objects to pass through alignment apparatus 413 in the positive Y-direction unaltered, i.e. without a change to the direction of polarization. Thus horizontal polarization 424 is equal to horizontal polarization 421. In other embodiments this need not be the case. In other embodiments, the polarization 424 can also comprise vertical polarization components. In other embodiments, alignment apparatus 409 need not maintain the horizontal polarization of objects moving through alignment apparatus 409 in the positive Y-direction. For example, the polarization of objects can be arbitrary or non-polarized after having moved through alignment apparatus 409 in the positive Y-direction.

The vertically polarized components of object 420 are transmitted through polarizing beam splitter 417, as indicated by trajectory 433 and object 422. Recall that alignment apparatus 409 and 413 are configured identically in this embodiment. Further recall that alignment apparatus 409 is configured to allow at least a portion of initially vertically polarized objects to pass through alignment apparatus 409 in the negative Y-direction unaltered, i.e. without a change to the direction of polarization. Thus vertical polarization 423 is equal to vertical polarization 422. In other embodiments this need not be the case, as described previously in the context of object 424 and object 421.

Trajectory 425 shows the trajectory of an object of interest which is located in the second reservoir 402 immediately prior to interacting with filtering apparatus 401. The object is initially not polarized on average, as indicated by polarization 426, which indicates an equal magnitude of polarization components in the horizontal direction, along the X-direction, and in the vertical direction, along the Z-direction. After having passed through second alignment apparatus 413 in the negative Y-direction, at least a portion of the horizontal polarization components of the object have been aligned with the vertical polarization axis, as shown by polarization 427. In the idealized embodiment, the transmissivity of objects through alignment apparatus 413 is unity. In other words, there is no reduction in the flux of objects of interest throughout alignment apparatus 413. In other embodiments, the transmissivity can be any number greater than zero and smaller than, or equal to, unity. The initially non-polarized objects of interest are primarily horizontally polarized after having passed through alignment apparatus 413 in the positive Y-direction.

The horizontally polarized components of object 427 are reflected by polarizing beam splitter 417, as indicated by trajectory 434 and object 428. Recall that alignment apparatus 409 and 413 are configured identically in this embodiment. Further recall that alignment apparatus 409 is configured to align the polarization of at least a portion of horizontally polarized objects moving in the negative Y-direction with the vertical axis, i.e. the Z-axis. In the simplified scenario the transmissivity of alignment apparatuses 409 and 413 is unity in either direction. Thus, in this simplified scenario, the vertical polarization 431 is equal in intensity to horizontal polarization 428, as indicated by the length of the double arrows 428 and 431. In other embodiments the intensity need not be same. For example, a portion of objects 428 can be absorbed or reflected by alignment apparatus 413. Furthermore, in some embodiments, the polarization 431 can also comprise horizontal polarization components. In other embodiments, alignment apparatus 413 need not alter the polarization of objects moving through alignment apparatus 413 in the negative Y-direction. For example, the polarization of objects can be arbitrary or non-polarized after having moved through alignment apparatus 413 in the negative Y-direction.

The vertically polarized components of object 427 are transmitted through polarizing beam splitter 417, as indicated by trajectory 435 and object 429. Recall that alignment apparatus 409 and 413 are configured identically in this embodiment. Further recall that alignment apparatus 413 is configured to align the polarization of at least a portion of vertically polarized objects moving in the positive Y-direction with the horizontal axis, i.e. the X-axis. In the simplified scenario the transmissivity of alignment apparatuses 409 and 413 is unity in either direction. Thus, in this simplified scenario, the vertical polarization 429 is equal in intensity to horizontal polarization 430, as indicated by the length of the double arrows 430 and 429. In other embodiment the intensity and polarization need not be as shown in FIG. 7, as described previously in the context of object 428 and object 431.

Consider the following illustrative, but arbitrary, numerical example. Throughout alignment apparatus 409, 50% of horizontally polarized components moving from first reservoir 401 in the negative Y-direction are aligned with the vertical polarization axis. The remaining 50% of horizontally polarized components are passed through alignment apparatus 409 without a change in the polarization direction. Of these unchanged horizontally polarized components, all are reflected by polarizing beam splitter 417 and transmitted through alignment apparatus 409 back into first reservoir 401. The remainder, i.e. the newly vertically polarized components and all originally vertically polarized components are transmitted through polarizing beam splitter 417 and transmitted through alignment apparatus 413 into second reservoir 402. The first transmissivity is 75%, for example.

Similarly, throughout alignment apparatus 413, 50% of vertically polarized components moving from second reservoir 402 in the positive Y-direction are aligned with the horizontal polarization axis. All horizontally polarized components, i.e. the newly horizontally polarized components and all originally horizontally polarized components, are reflected by polarizing beam splitter 417 and transmitted through alignment apparatus 413 back into second reservoir 402. The remainder, i.e. all unchanged and originally vertically polarized components, are transmitted through polarizing beam splitter 417 and transmitted through alignment apparatus 409 into first reservoir 401. The second transmissivity is 25%, for example. In other words, an object in the first reservoir 401 which interacts with channel 408 of the filtering apparatus 400 is three times more likely to be transmitted into the second reservoir 402 than an object in the second reservoir 402 which interacts with channel 408 of the filtering apparatus 400 is likely to be transmitted into the first reservoir 401.

As a result, a larger fraction of objects which enter channel 408 from the first reservoir 401 are transmitted to the second reservoir 402 compared to the fraction of objects which enter channel 408 from the second reservoir 402 and are transmitted to the first reservoir 401. In other words, the first transmissivity is larger than the second transmissivity. This results in a net diffusion or a bulk flow of objects from the first reservoir 401 to the second reservoir 402 for a dynamic boundary condition, or a larger concentration of objects in the second reservoir 402 compared to the first reservoir 401 for a static boundary condition.

As mentioned, several filtering apparatuses 400 can be arranged in series and in parallel to enhance the magnitude of said net diffusion or said difference in concentration.

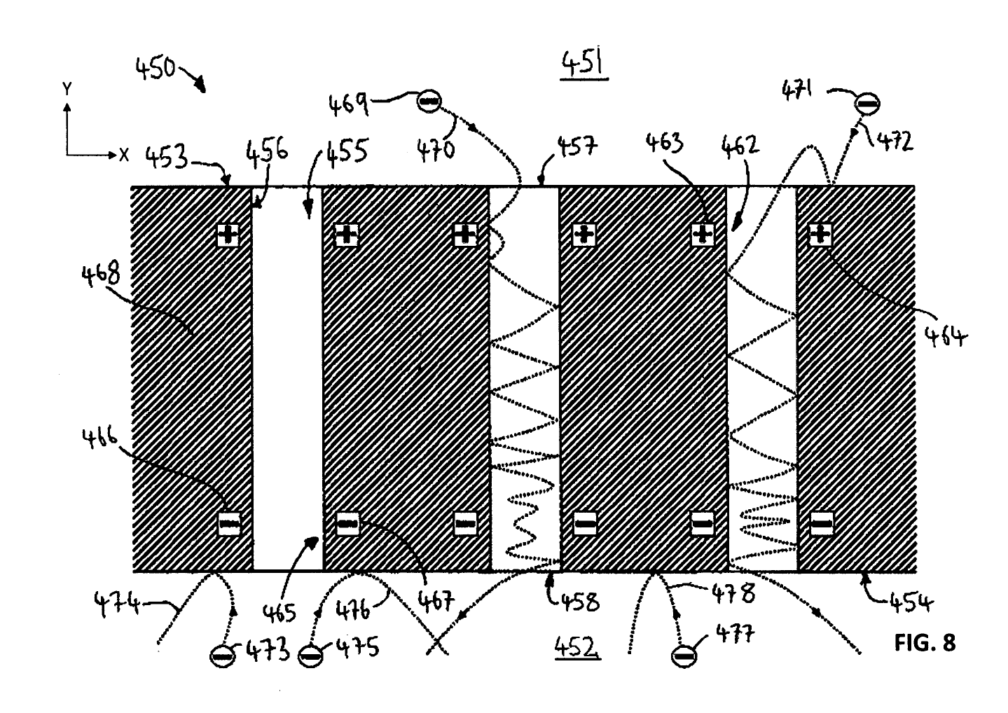

FIG. 8 shows a cross-sectional view of an embodiment configured to interact with charged particles.

There is a first reservoir 451, and a second reservoir 452. A filtering apparatus 450 comprises a first surface 453 and a second surface 454. Several identical channels, such as channel 455, allows objects of interest to pass from the first reservoir 451 through a first opening 457 and a second opening 458 through the filtering apparatus to the second reservoir 452.

The filtering apparatus comprises bulk material 468, which is configured in a manner in which the reflectivity of the surfaces of bulk material 468 with respect to objects, such as objects 469 and 471, is greater than zero. The medium in the first reservoir 451, the second reservoir 452, and within the channels can be a metal conductor, for example, and the objects of interest can be electrons, for example. In this case, the bulk material can be an electrical insulator or a semi-conductor, for instance. In another example, the medium in the first and second reservoirs adjacent to the filtering apparatus can comprise ions. These ions can be present naturally, such as the sodium and chorine ions found in salt water, or can be produced artificially through ionization of the medium in the vicinity of the filtering apparatus. For example, air molecules can be ionized in the vicinity of a channel opening, and the probability of entering a channel can be controlled by a focusing or defocusing apparatus located at the opening of a channel. Note that, in some embodiments, a channel can comprise only a focusing apparatus, or only a defocusing apparatus.

Note that bulk material 468 in the vicinity of a collection of charge is configured in a manner in which the electric field produced by the collection of charge is transferred into the medium, such as an adjacent or corresponding channel and an adjacent reservoir, such as a first reservoir 451. For example, bulk material 468 can be a dielectric within the portion of bulk material 468 located between a charge collection and the medium in a channel or an adjacent reservoir. For instance, bulk material 468 can be an insulator such as glass, or plastic, or a semiconductor such as silicon in these regions.

A first focusing apparatus, such as first focusing apparatus 456, comprises several collections of positive charge, such as charge collection 463 and 464, arranged in annular fashion around the corresponding channel. Since the objects of interest are negatively charged, the first focusing apparatus 456 is configured to attract objects of interest in the adjacent first reservoir 451 to the corresponding first channel opening and the interior of the corresponding channel. This is exemplified by the trajectory 470 of object 469 and trajectory 472 of object 471.

Each channel comprises a first defocusing apparatus, such as first defocusing apparatus 465, which comprises several collections of negative charge, such as charge collection 466 and 467, arranged in annular fashion around the corresponding channel. Since the objects of interest are negatively charged, the first defocusing apparatus 465 is configured to repel objects of interest in the adjacent second reservoir from the corresponding first channel opening and to prevent these objects from entering the interior of the corresponding channel. This is exemplified by the trajectory 474 of object 473, trajectory 476 of object 475, and trajectory 478 of object 477.

As a result of the focusing and defocusing apparatuses, the number density of objects of interest in the first reservoir 451 in the immediate vicinity of the first opening of a channel is increased artificially and passively, while the number density of objects of interest in the second reservoir 452 in the immediate vicinity of the second opening of a channel is decreased artificially and passively. The increase and decrease are measured relative to the average number density of objects of interest in the first reservoir 451 and the second reservoir 452 in the baseline scenario, or in a theoretical scenario in which the reservoirs are infinite in size and in which the measurements are made an infinite distance from the filtering apparatus. This artificial increase in the number density of objects of interest in the vicinity of a first opening of a channel increases the flux of objects of interest from the first reservoir 451 into the channel. Similarly, the artificial decrease in the number density of objects of interest in the vicinity of a second opening of a channel decreases the flux of objects of interest from the second reservoir 452 into the channel. The increase and decrease are measured relative to the average flux of objects of interest in incident on the baseline apparatus from the first reservoir 451 and from the second reservoir 452 in the baseline scenario. Due to the modification of the flux incident on the first and second channel openings, there is a net diffusion of objects of interest in the negative Y-direction for a dynamic boundary condition, and a larger density, pressure, or concentration of objects of interest in the second reservoir 452 compared to the first reservoir 451 for a static boundary condition.

In other embodiments, first defocusing apparatus 465 can be replaced, or augmented by, a second focusing apparatus. The second focusing apparatus can comprise several positive collections of charge located within bulk material 468 in the proximity of second surface 454 and located a sufficiently far distance from a corresponding channel opening to attract objects of interest, which would otherwise enter the channel, away from the corresponding second channel opening, such as second channel opening 458, and deflect the trajectories of these objects of interest in a manner in which these objects of interest collide with, and are reflected by, the second surface 454 and returned to the second reservoir 452. In the cross-sectional view shown in FIG. 8, the charge collections of the second focusing apparatus can be located at the same location along the Y-axis as a negative charge collection, such as negative charge collection 467, and located half-way between adjacent channels. For example, in a cross-sectional view along the Y-direction, the centers of individual charge collections of the second focusing apparatus can be located in a hexagonal pattern, with each channel located at the center of the hexagons. In other embodiments, the charge collections associated with a second focusing apparatus can be located in annular fashion around a channel in a plane parallel to the XZ-plane, where the radius is sufficiently large that objects of interest, such as object 473 or object 475 are focused towards second surface 454 of bulk material 468 as opposed to being focused towards a second channel opening, such as second channel opening 458.

Similarly, in other embodiments, first focusing apparatus 455 can be replaced, or augmented by, a second defocusing apparatus. The second defocusing apparatus can comprise several negative collections of charge located within bulk material 468 in the proximity of first surface 453 and located a sufficiently far distance from a corresponding channel opening to repel objects of interest from colliding with first surface 453 and to direct objects of interest towards a corresponding first channel opening, such as first channel opening 457. In the cross-sectional view shown in FIG. 8, the charge collections of the second defocusing apparatus can be located at the same location along the Y-axis as a positive charge collection, such as positive charge collection 464, and located half-way between adjacent channels. For example, in a cross-sectional view along the Y-direction, the centers of individual charge collections of the second defocusing apparatus can be located in a hexagonal pattern, with each channel located at the center of the hexagons. In other embodiments, the charge collections associated with a second defocusing apparatus can be located in annular fashion around a channel in a plane parallel to the XZ-plane, where the radius is sufficiently large that objects of interest, such as object 469 or object 472 are focused towards a first channel opening, such as first channel opening 457.

In other embodiments, the objects of interest, such as object of interest 469, can be positively charged instead of negatively charged. For example, the objects of interest can be positively charged ions. In such embodiments, the charge collections of the focusing apparatus, such as charge collections 463 of focusing apparatus 462, can be negatively charged, and the charge collections of a defocusing apparatus, such as charge collection 467 of defocusing apparatus 465, can be positively charged.

In other embodiments, the objects of interest, such as object 469, can also be electric dipoles instead of charged particles. For example, the objects of interest can be neutral objects, such as atoms, which can be polarized by an externally applied electric field, such as the field produced by a collection of charge, such as charge collection 463. In this example, an electrical dipole is induced by the externally applied electric field. In other examples, the objects of interest can carry a permanent electric dipole, as is the case for water molecules, for example. Electric dipoles experience an attractive force in a direction of increasing magnitude of electric field strength. In such embodiments, therefore, a first focusing apparatus can be configured in a similar manner as first focusing apparatus 462 in FIG. 8. Note that, in this case, the sign of the charge of the charge collections of first focusing apparatus 462 can be positive or negative. In such embodiments, a defocusing apparatus configured in a similar manner as defocusing apparatus 465 would be counterproductive, because such a defocusing apparatus would behave in the similar manner as a focusing apparatus when interacting with electric dipoles. Therefore, embodiments configured to interact with electric dipoles can, instead of defocusing apparatuses, such as defocusing apparatus 462, comprise a second focusing apparatus configured in a similar manner as the aforementioned second focusing apparatus. Specifically, and as described in more detail previously, the second focusing apparatus can comprise several positive or negative collections of charge located within bulk material 468 in the proximity of second surface 454 and located a sufficiently far distance from a corresponding channel opening to attract objects of interest, i.e. electric dipoles, which would otherwise enter the channel, away from the corresponding second channel opening, such as second channel opening 458, and deflect the trajectories of these objects of interest in a manner in which these objects of interest collide with, and are reflected by, the second surface 454 and returned to the second reservoir 452.

For the embodiment shown in FIG. 8, the individual charge collections of a focusing or defocusing apparatus, such as charge collection 463 and charge collection 464 of focusing apparatus 462, are electrically insulated from each other. This reduces or mitigates any field asymmetries or undesired migration or redistribution of charge due to manufacturing inaccuracies, for example.

Each charge collection can comprise several ions embedded within bulk material 468 in some embodiments. In other embodiments, the charge collections can be connected to a voltage source, such as a battery or capacitor, via electrical conductors, such as copper wires. For example, the positive terminal of a voltage source such as a battery can be electrically connected to the positively charged charge collections, such as charge collection 463 and charge collection 464, while the negatively charged terminals of said voltage source can be electrically connected to the negatively charged charge collections, such as charge collection 467 and charge collection 466. The magnitude of the electrical potential difference between the positive and negative terminals of the voltage source can be regulated by a voltage regulator, for example. The voltage regulator can be configured to change the voltage in continuously variable fashion between a range of voltages. By controlling the magnitude of the voltage applied to the charge collections, the strength of the electric field produced by charge collections can be manipulated, and the strength of the focusing effect of a focusing apparatus or the strength of the defocusing effect of a defocusing apparatus can be regulated and controlled. The rate of diffusion, or the flow rate of bulk flow through the filtering apparatus, or the thrust produced by the filtering apparatus, can thus be controlled for a dynamic boundary condition. Similarly, the difference in the pressure, density, or concentration of objects of interest in the second reservoir 452 relative to the first reservoir 451 can be controlled.

The magnitude of the voltage applied to the charge collections to embodiments of the invention, such as example embodiments shown in FIG. 1, FIG. 2, and FIG. 8, is configured to be sufficiently large to affect the trajectories of objects of interest by a non-negligible amount. Note that, in some embodiments, it is desirable for the electric field generated by the collections of charge to not ionize or otherwise alter the charge of objects of interest. Ionization consumes power and ionized objects of interest can damage bulk material, such as bulk material 468 or bulk material 302, or bulk material 966. For example, in the case in which the objects of interest are air molecules, the charge density and the geometric arrangement of charge within a filtering apparatus is configured in a manner in which the maximum electric field strength does not exceed the dielectric strength of objects of interest. In addition, the collections of charge are configured in a manner in which the electric field strength within the bulk material does not exceed the dielectric strength of the bulk material, i.e. the externally applied voltage does not exceed the breakdown voltage of the bulk material or the surrounding medium.

As mentioned, in other embodiments, it can be desirable for the electric field generated by a filtration apparatus to ionize objects of interest. For example, the objects of interest can be air molecules, and the filtering apparatus can be configured in a similar manner as the filtering apparatus shown in FIG. 8. When the air molecules are ionized, the performance of a filtering apparatus can be improved compared to a filtering apparatus configured to interact with electric dipoles or polarized air molecules. The increase in the performance can refer to an increase in the flux or the rate of diffusion or the magnitude to the bulk flow velocity of objects of interest through the filtering apparatus for a dynamic boundary condition, or the difference in pressure or density of objects of interest in a second reservoir compared to a first reservoir. The increase in performance can be a result of the larger magnitude of electromagnetic forces applied to individual, ionized or charged objects of interest. Recall that, in the case in which the objects of interest are charged, electric fields can be used to apply forces on the objects of interest, as opposed to electric field gradients. A stronger interaction between a collection of charge and an object of interest can enhance the focusing or defocusing effect of collections of charge, and increase the aforementioned performance of a filtering apparatus.

An electrical switch can be employed to cut off the voltage supply to the charge collections, such that each conductor of a charge collection is neutrally charged. In this configuration, there is no net diffusion and no bulk flow through the filtering apparatus for a dynamic boundary condition, and no difference in pressure, density, or concentration of objects of interest in the first and second reservoirs for a static boundary condition.

The characteristic dimension of an embodiment configured in a similar manner as embodiment 450 is the shortest distance between the first surface 453 and the second surface 454, i.e. the characteristic length of a channel, such as channel 455. In embodiments in which the width or the diameter of a channel is larger than the length of a channel, the characteristic dimension is the width of a channel. As mentioned in the context of the other embodiments discussed herein, the characteristic dimension of an embodiment of the invention is smaller than 1000 times the smallest mean free path of an object of interest in a reservoir adjacent to a channel. For example, the characteristic dimension of a filtering apparatus can be 10 times the smallest mean fee path of an object of interest in an adjacent reservoir. For example, the characteristic dimension of a filtering apparatus can be one times the smallest mean fee path of an object of interest in an adjacent reservoir. For example, the characteristic dimension of a filtering apparatus can range from the minimum cross-sectional dimension of an object of interest to 1000 times the smallest mean fee path of an object of interest in an adjacent reservoir.

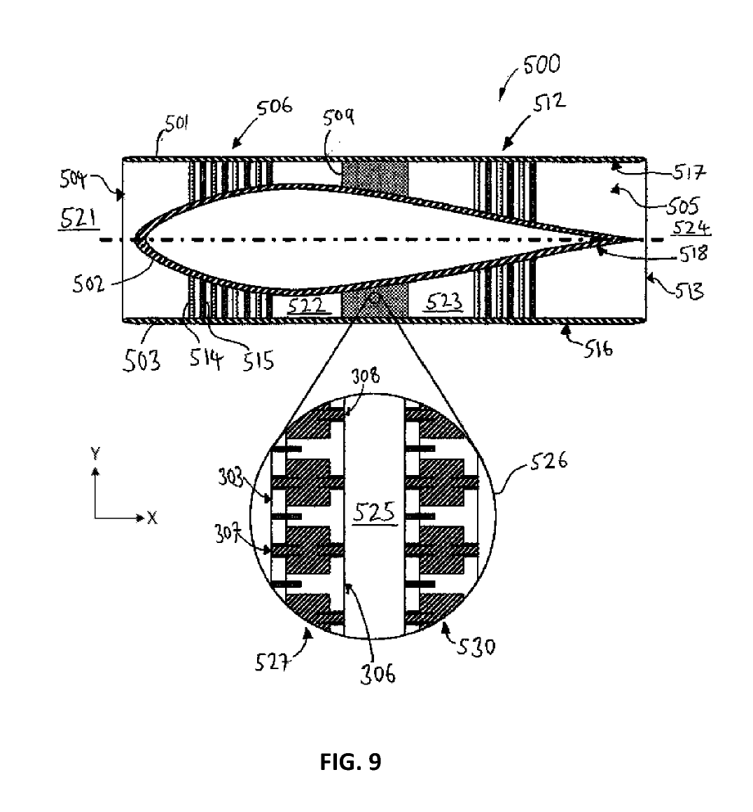

FIG. 9 shows an example application of embodiments of the invention. In this example, embodiments of the invention are employed in a turboshaft engine or turbojet engine.

Engine 500 comprises an annular channel 505 located between an inlet 504 and an outlet 513. The channel is bounded by interior surface 517 of outside casing 501 and the exterior surface 518 of shaft 502. The bulk material 503 can be a metal such as aluminum or titanium, or a composite material such as carbon fiber or fiberglass.

Engine 500 comprises an axial compressor 506 with 4 stages of rotor discs and stator discs, such as rotor disc 514 and stator disc 515 of the first stage. Each disc comprises several radially arranged fan blades, as is common practice for conventional turboshaft or turbojet engines.

Engine 500 also comprises an axial turbine 512 with 3 stages of rotor discs and stator discs configured in a similar manner as those of the compressor 506. At least a portion of the power extracted from the gas is transferred via central shaft 502 from the turbine 512 to compressor 506. Any remaining power can be transferred via a shaft to an external power sink, such as the fan of a turbofan engine, the propeller of a turboprop engine, the rotors of a helicopter, or an electric generator where the mechanical power can be converted into electrical power. Alternatively, any excess energy contained within the working gas can be employed to accelerate the working gas in the positive X-direction before exiting outlet 513. In such a configuration, engine 500 can be considered to be a turbojet engine.

A filtering apparatus 509 configured in accordance with the invention is located downstream of the compressor 506 and upstream of turbine 512. The working gas can be air, for example. In this case, the objects of interest are air molecules. The filtering apparatus 509 is configured to increase the effective transmissivity of air molecules diffusing through filtering apparatus 509 in the positive X-direction, and decrease the effective transmissivity of air molecules diffusing through filtering apparatus 509 in the negative X-direction. As shown in enlargement 526, filtering apparatus 509 comprises several layers, such as layer 527 and layer 530, where each layer is a planar filtering apparatus configured in a similar manner as the filtering apparatus shown in FIG. 1, and the plane of each layer is parallel to the YZ-plane in FIG. 9.

Due to the action of the filtering apparatus, the density of the objects of interest, i.e. the air molecules, is larger at station 525 than at upstream station 522, and larger at station 523 than at upstream station 525. In a simplified model, this increase in pressure and density can be considered to proceed isothermally. In other words, there can be an adiabatic reduction in entropy between station 522 and station 523 due to the action of the filtering apparatus 509. Due to the increase in pressure at station 523 compared to station 523, turbine 512 can extract more work than is consumed by compressor 506, resulting in a net work output from the working material, i.e. the air flowing through engine 500. The energy for the work is provided by the thermal energy of the gas molecules, resulting in a lower temperature at station 524 compared to station 521. Note that the isothermal compression between station 523 and 522 can be considered to not do any work on or extract work from the gas. In other embodiments, or in more accurate models, in which the bulk flow of the gas molecules relative to the filtering apparatus 509 is taken into account, the compression between station 523 is not isothermal, but accompanied by an expansion and cooling of the gas. This is due to the deceleration of gas molecules colliding with the second surfaces, such as surface 308 of the filtering apparatus. Note that, due to the increase in density a larger number of gas molecules collide with the second surfaces 308 than with the first surfaces 307 of the filtering apparatuses, resulting in a net cooling effect. This effect does work on the filtering apparatus, and provides thrust in the negative X-direction. This effect is particularly relevant at large bulk flow velocities at stations 522 and 523.

Note that air molecules can be polarized by an externally applied electric field. The mean free path of nitrogen is approximately 60 nanometers at standard pressures and temperature. Note that the mean free path is reduced by the compression of the air by compressor 506. In other embodiments, a turbine, such as turbine 512 can be located upstream of filtering apparatus 509 in place of compressor 506, and a compressor, such as compressor 506, can be located downstream of the filtering apparatus in place of turbine 512. In such embodiments, the pressure at station 522 is lower than the pressure at station 521. Note that the pressure at station 523 is still larger than the pressure at station 523. Thus, in this alternate embodiment, the turbine will extract more work from the air between station 521 and station 522 than the compressor consumes in compressing the air between station 523 and 524, resulting in a net work output of engine 500. The benefit of such an alternative embodiment can be the fact that the mean free path at station 522 can be lower than the mean free path for the embodiment shown in FIG. 9 at the same station. This increases limit on the size constraint on the filtering apparatus 509, and can improve manufacturability of the filtering apparatus.

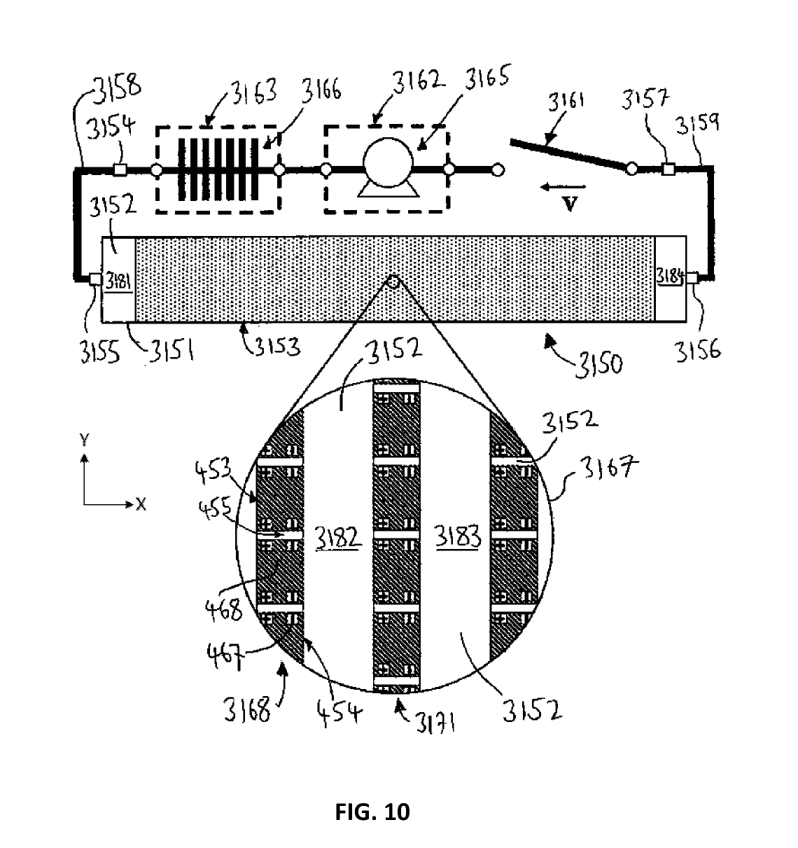

FIG. 10 is a cross-sectional view of an application of an embodiment of the invention in an electrical power supply.

A filtering apparatus 3153 is embedded within a conductor 3151 and configured to interact with electrons as objects of interest. The bulk material 468 of the filtering apparatus can be a material with a lower electrical conductivity compared to bulk material 3152 of the conductor 3151, i.e. the medium in which the electrons are moving primarily. As shown by enlargement 3167, the filtering apparatus comprises several layers of filtering apparatuses arranged in series, such as layer 3171 or layer 3168, where each layer comprises a filtering apparatus configured in a similar manner as the filtering apparatus shown in FIG. 8. The direction of bulk flow of electrons is in the positive X-direction for a dynamic boundary condition.

The filtering apparatus 3150 can be considered to be a current source, and electrical contacts 3154 and 3157 can be considered to form the terminals of the current source. Filtering apparatus 3150 can also be considered to be a battery. The energy for the current source, i.e. for the flow of electrons or the accumulation of electrons at the terminals of the current source is provided by the thermal energy of the electrons and any material in thermal contact with the electrons, such as bulk material 3152 of conductor 3151. Note that bulk amteral 3152 is in thermal contact with the electrons contained within bulk material 3152 via phonon-electron collisions, i.e. collisions between electrons and the atoms of the lattice of the bulk material 3152. The electrical contacts are connected to the conductor by electrical conductors, such as electrical conductors 3158, 3159, and contacts 3155 and 3156.

In the particular application shown, there is a switch 3161 which can also be used to regulate the current flow of the current source using pulse width modulation, for example. In some embodiments the switch 3161 comprises transistors or other electronic devices suitable for modulating or regulating current or voltage.

In a static boundary condition, i.e. when the switch 3161 is in an open position, there is a larger concentration of electrons at station 3184 and contact 3156 than at station 3181 and contact 3155 due to the action of the filtering apparatus. Within the filtering apparatus, the concentration of electrons at station 3183 is larger than the concentration at station 3182. This is due to the high transmissivity of electrons diffusing from station 3182 to station 3183 through the channels of the filtering apparatus in the positive X-direction, and the comparatively lower transmissivity of electrons diffusing from station 3183 to station 3182, as discussed in the context of FIG. 10. Thus there is a voltage difference “V” across the terminals of the open circuit.

In a dynamic boundary condition, the circuit is closed and electrons are allowed to flow through a load 3162. The load 3162 can be a resistor, a computer, a smartphone, or other device which nominally consumes electrical power, for example. In the embodiment shown, the load 3162 is an electric motor 3165 configured to do mechanical work. Since the energy associated with the bulk flow of electrons through the conductors is provided by the thermal energy of the electrons, the thermal energy needs to be replenished for continuous, steady state operation. Due to the electrons doing external work, i.e. work on the environment, in load 3162, the temperature of the electrons having flown through the load 3162 is lower than the nominal temperature at station 3181 for the corresponding static boundary condition. The replenishment of electron thermal energy can be enhanced by a heat exchanger 3163, which, in the depicted embodiment comprises several metal plates 3166 configured to extract heat from the environment, such as the atmosphere, or the room in which the heat exchanger 3163 is located. The heat exchanger 3163 can recover thermal energy from the environment via conduction, forced or natural convection, or thermal radiation, for example.

In some embodiments, the load 3162 and the heat exchanger 3163 are identical. For example consider a simplified scenario in which no work is done by the electrons on the environment, and no energy is transferred from the environment to the electrical circuit, and vice versa. In this example, the load resistor can be thermally insulated, for example. The electrons within the circuit can be considered to be in an isolated system. In this system the electrons diffusing from station 3181 to station 3184 will experience a reduction in temperature and an increase in electrical potential energy. The higher electrical potential at station 3184 is due to a larger concentrations of electrons at station 3184 than at station 3181. In other words, the thermal energy of the electrons is converted into electrical potential energy. When the electrons subsequently flow from station 3184 to station 3181 through the load resistor, the electrical potential energy is converted into thermal energy due to Joule heating. This thermal energy is returned to the electrons in the load resistor and at station 3181 via thermal conduction. In the steady state, all of the electrical potential energy per unit time transferred by the electrons to a load resistor in the form of Joule heating is returned to the electrons via thermal conduction in this simplified example. In this simplified example, therefore, the circuit comprising the filtering apparatus 3151 will comprise a finite current which will continue to flow continuously in the steady state.

Note that, in some embodiments the diffusion of electrons from station 3181 to station 3184 of larger electron concentration and larger electrical potential energy is not adiabatic, and thermal energy will be conducted to the electrons at station 3184 from other portions of the electrical circuit, such as the load resistor. The thermal energy can be conducted via conductor 3159 or conductor 3154 for example. In some embodiments, the increase in concentration of electrons at station 3184 compared to station 3181 is an isothermal process as opposed to an adiabatic process being discussed in the aforementioned simplified example. The general principles remain unchanged, however.

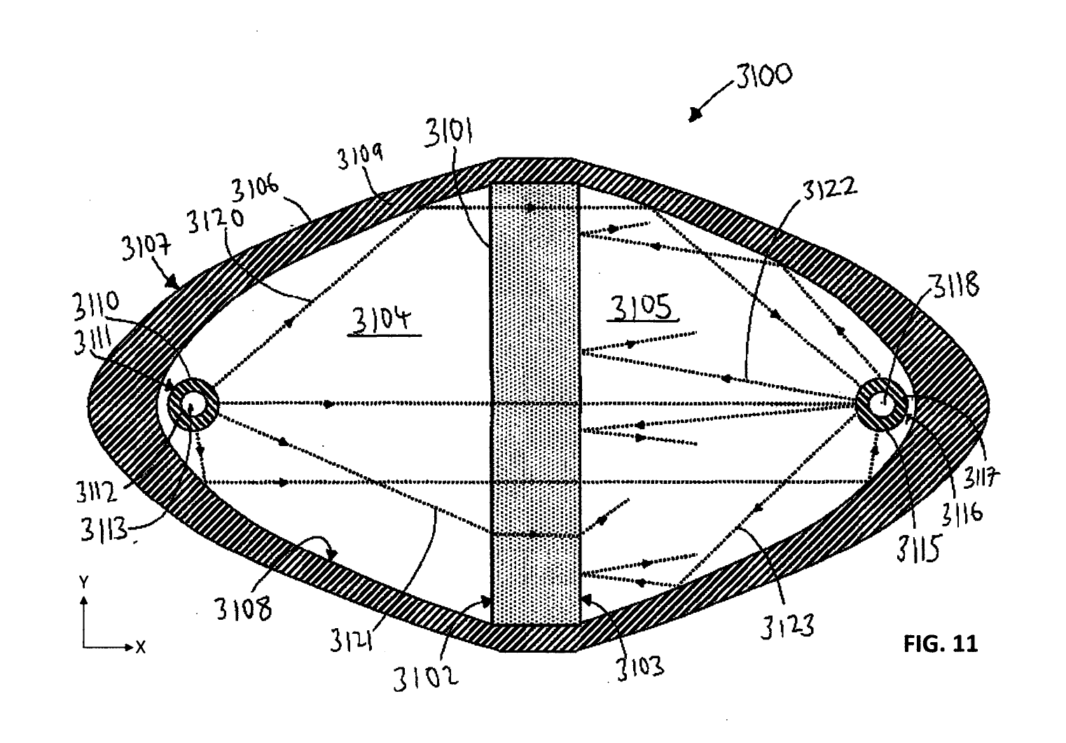

FIG. 11 is a cross-sectional view of an application of an embodiment of the invention in a heat transfer apparatus.

A first thermal source 3110 is located in a first thermal reservoir 3104 and a second thermal source 3115 is located in a second thermal reservoir 3105. The shape of the interior walls of the thermal reservoirs, such as interior wall 3108 of thermal reservoir 3104, is configured to direct the radial radiation pattern emitted by each thermal source within the thermal reservoir in the positive and negative X-direction, as exemplified by photon trajectory 3120 and trajectory 3121. The shape can be found by those skilled in the art and deviates from a parabolic shape by small amounts.

The interior surface of walls 3106 is configured to be highly reflective to the photons emitted by thermal sources 3115 and 3110. The interior surface walls can be a highly electrically conducting material such as silver or another metal, such as aluminium, for example. In some applications, the photons emitted by the thermal sources are in the infrared regime. The bulk material 3109 of wall 3106 is configured to be a highly thermally insulating material, such as polystyrene. In some embodiments wall 3106 comprises hollow portions which contain a vaccum or a low pressure gas. This can further reduce the thermal conductivity, and prevent any undesired heat flow out of reservoir 3104, 3105, or filtering apparatus 3101. This undesired heat flow excludes any desired heat flow, such as the heat flow due to pumping of thermal fluid through pipes 3110 and 3118. The outside surface 3107 of wall 3106 is indicated.

The cross-section of a thermal reservoir viewed in the X-direction can be rectangular, elliptical, or circular. The cross-section of the thermal sources can be rectangular, or circular. In this embodiment, thermal source 3110 and 3115 are cylindrical pipes. For example, thermal source 3110 and 3115 can be configured in a similar manner as the cylindrical pipes located at the focal point in solar concentrators. In The bulk material 3117 and 3112 is a highly thermally conduction material, such as copper. Contained within each pipe there is a thermal fluid which is pumped through the pipe. The thermal fluid can be employed to transfer heat to other thermodynamic apparatuses, such as heat engines, heat pumps, or thermodynamic reservoirs, such as refrigerating chambers, the interiors of houses, a body of water, the ground, or the atmosphere. For practical purposes, consider the thermal fluid 3113 in pipe 3110 to be thermally connected to a first external reservoir and the thermal fluid 3118 in pipe 3115 to be thermally connected to a second external reservoir. In the static boundary condition, the first and second external reservoirs are otherwise thermally insulated from each other and any other reservoirs.

Due to the finite temperature of the thermal fluid 3113, thermal energy is conducted through bulk material 3112 to surface 3111, where it is emitted in the form of thermal radiation, such as photon 3120. Similarly, due to the finite temperature of the thermal fluid 3118, thermal energy is conducted through bulk material 3117 to surface 3116, where it is emitted in the form of thermal radiation, such as photon 3122 or photon 3123. On average, thermal radiation emitted by thermal source 3110 and 3115 is not polarized.

A filtering apparatus 3101 configured in accordance with the invention is located between reservoir 3104 and reservoir 3105. For example, filtering apparatus 3103 can be configured in a similar manner as the filtering apparatus shown in FIGS. 6 and 7. The filtering apparatus 3103 has a first surface 3102 and a second surface 3103.

Due to the action of the filtering apparatus, only a fraction of the photons emitted by the second thermal source 3115 are transmitted to the first thermal source 3110, while a larger fraction of the photons emitted by the first thermal source 3110 are transmitted to the second thermal source 3115. Thus heat can be transferred from the first reservoir to the second reservoir. Due to the difference in transmissivity, the first reservoir can be colder than the second reservoir in thermal equilibrium. In other words, heat can be transferred from a cold object to a warm object, relatively speaking. This concept can be used to power a heat engine which converts thermal energy directly into mechanical work, for example. The apparatus thus described can be considered to be a heat transfer apparatus and the filtering apparatus can be considered to be a temperature amplifier. Due to the presence of the filtering apparatus between the first reservoir and the second reservoir, the absorptivity of the second reservoir is larger than the emissivity of the second reservoir, as perceived by the first reservoir. In the scenario in which the first and second thermal sources are constructed to be identical, and in a static boundary condition, the temperature of the second external reservoir is larger than the temperature of the first external reservoir.

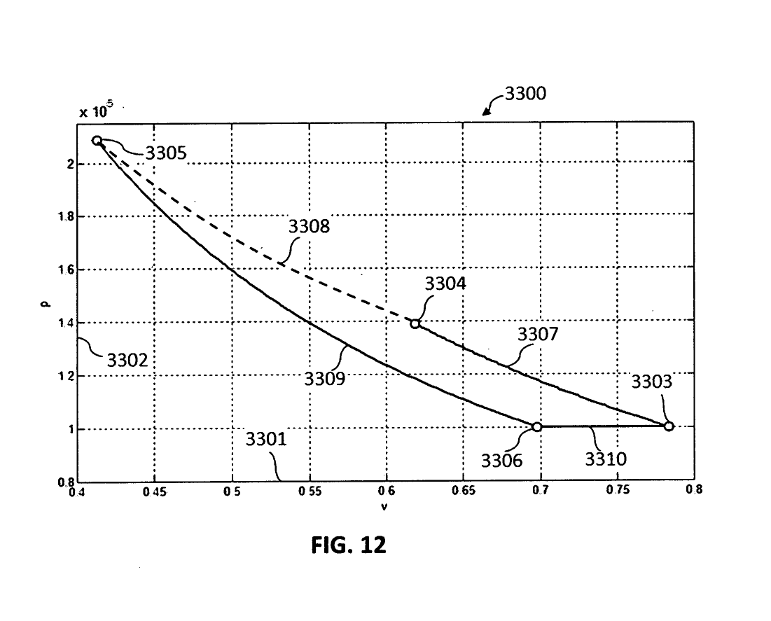

FIG. 12 is a plot of the value of pressure 3302 versus specific volume 3301 of air which passes through an example embodiment of the invention, such as the example embodiment shown in FIG. 9.

The thermodynamic cycle in plot 3300 shows a first point 3303, a second point 3304, a third point 3305, and a fourth point 3306. The fifth point and the first point are coincident. Following an adiabatic compression 3307, a gas at free stream condition 3303 encounters a filtering apparatus configured in accordance with the invention, within which the gas is compressed isothermally, as shown by dashed line 3308. Note that this isothermal compression occurs passively, and does not extract work from, or deliver work to, the gas, in this particular example. The gas is subsequently expanded adiabatically 3309. At station 3306, the gas is expelled into the free stream at free stream pressure. In the free stream the gas is heated isobarically 3310. The gas at station 3306 is colder than at station 3303, and the net mechanical work produced by the cooling of the gas is the difference in the work of adiabatic expansion 3309 and adiabatic compression 3307.

Stations 3303, 3304, 3305, and 3306 can be considered to correspond to stations 521, 522, 523, and 524, respectively, in FIG. 9 for a subset of embodiments.

Other thermodynamic cycles, such as closed cycles or cycles involving isochoric or isothermal compression or expansion as opposed to adiabatic compression or expansion, employing filtering apparatuses configured in accordance with the invention can be readily constructed by those skilled in the art. The values of the pressures for this cycle are arbitrary and chosen for illustrative purposes, and are not intended to limit the scope of the invention.

Unless specified or clear from context, the term “or” is equivalent to “and/or” throughout this paper.

An apparatus unit for selectively transmitting objects of interest can comprise a bulk material; a throat disposed within the bulk material and extending from the first throat opening to a second throat opening; and a first alignment apparatus disposed in proximity to the throat, wherein the alignment apparatus is configured to align objects of interest with respect to the throat within less than 1000 mean free path lengths of the objects of interest from the first throat opening. A throat is a directional element that can diffusively couple a first reservoir and a second reservoir. Interaction of the objects of interest with the focusing apparatus can increase or decrease the probability that the objects of interest pass through the throat. Selectively transmitting can comprise changing a trajectory of the objects of interest or a property of the objects of interest in such a way that the objects have a higher probability of passing through throat. For example, objects can be aligned to pass through the throat or to be reflected from the apparatus.

A throat can have any suitable shape and can have segments that have a larger or smaller area than other segments. For example, a throat can comprise a first channel, a second channel, and a narrow throat coupling the first and second channels, where the first and second channels have a large cross-sectional area than the throat.

A throat can have a cross-sectional area that is larger than a smallest cross-sectional area of an object before interacting with the apparatus unit; and smaller than the largest cross-sectional area of the object after interacting with the apparatus unit.

A bulk material comprises wherein the bulk material comprises a metal, a metal alloy, a ceramic, a composite, a thermoplastic, a thermoset, a semiconducting material, electrically insulating material, a semiconducting material, an electrically insulating material, a glass, or a combination of any of the foregoing. Inner surfaces of the bulk material can be configured to reflect the objects of interest.

The alignment apparatus can be configured to generate an electromagnetic field aligned such that objects of interest interacting with the electromagnetic field have a higher probability of entering the throat. An apparatus subunit can comprise one or more alignment apparatus. An alignment apparatus can generate an electromagnetic field having any suitable alignment with respect to the longitudinal axis of the throat. An alignment apparatus can comprise one or more charge collections and/or one or more dipole collections. An alignment apparatus can be disposed within the bulk material in proximity to the throat, such as in proximity to the first throat opening and/or the second throat opening. The charge/dipole collections can be in the shape of annular rings, annular ring sections, a plate, a cylinder, cylinder sections, or any suitable shape. The electromagnetic field can be an electrical field or a magnetic field. Charge collections can comprise an electrically conductive material interconnected to an electrical potential. Charge collections can comprise electrons or ions embedded within an electrically insulating or semiconducting material. Dipole collections can comprise dipoles such as permanent magnetic dipoles embedded within an electrically insulating or semiconducting material.

Alignment apparatus can be configured, for example, to align objects of interest with a throat opening, change the shape of objects of interest, change an orientation of an object of interest or change a vector property of the objects of interest. Changing a vector property can comprise, for example, rotating a vector property of the objects of inters and/or modifying the magnitude of a vector property of an object of interest. A vector property can comprise, for example, a polarization axis, a magnetic dipole axis, a principal axis as derived by an inertia tensor, or a geometric long axis as derived by the geometric shape of the objects of interest. An electromagnetic field can be configured to exert moments or torques about the center of mass of the o objects of interest. An electromagnetic field can be configured to generate a force field on the objects of interest.

An object of interest can be particle such as dust particles, soot particles, water droplets, water molecules, or a combination of any of the foregoing.

Alignment can occur within less than 10 mean free path lengths of the objects of interest, such as less than 1 mean free path length.

Systems provided by the present disclosure can comprise one or more of the apparatus units. Apparatus units can be provided of arrays having, for example, from 1 to 100,000,000 apparatus units. Planar arrays of apparatus units can be stacked on top of each other and/or side by side. One or more apparatus units in a planar array can be diffusively coupled to one or more apparatus unit in another planer array. For example, a second throat opening of a first apparatus unit is diffusively coupled to a first throat opening of a second apparatus unit.

Method provided by the present disclosure for selectively transmitting objects of interest from a first reservoir to a second reservoir can comprise providing the apparatus unit provided by the present disclosure, wherein the first throat opening is diffusively coupled to the first reservoir and the second throat opening is diffusively coupled to the second reservoir; and generating a force field by activating the first alignment apparatus; thereby causing a selective transmission of the objects of interest from the first reservoir to the second reservoir.

Methods provided by the present disclosure for selectively transmitting objects of interest from a first reservoir to a second reservoir, can comprise providing the system provided by the present disclosure, wherein the first throat opening is diffusively coupled to the first reservoir and the second throat opening is diffusively coupled to the second reservoir; and generating a force field by activating the first alignment apparatus; thereby causing a selective transmission of the objects of interest from the first reservoir to the second reservoir.

The embodiments and methods described in this paper are only meant to exemplify and illustrate the principles of the invention. This invention can be carried out in several different ways and is not limited to the examples, embodiments, arrangements, configurations, or methods of operation described in this paper or depicted in the drawings. This also applies to cases where just one embodiment is described or depicted. Those skilled in the art will be able to devise numerous alternative examples, embodiments, arrangements, configurations, or methods of operation, that, while not shown or described herein, embody the principles of the invention and thus are within its spirit and scope.

### ASPECTS OF THE INVENTION

The invention is further defined by the following aspects.

Aspect 1. An apparatus unit for selectively transmitting objects of interest, wherein the apparatus unit comprises: a bulk material; a throat disposed within the bulk material and extending from a first throat opening to a second throat opening opposite the first throat opening; and wherein the throat has length that is less than 1000 mean free path lengths of the objects of interest before interacting with the apparatus unit; and a first focusing apparatus, wherein the first focusing apparatus is disposed within the bulk material and in proximity to at least a portion of the throat.

Aspect 2. The apparatus unit of aspect 1, wherein the first focusing apparatus comprises: an inside apparatus disposed within at least a portion of the throat; an inside focusing apparatus disposed within the inside apparatus; and an outside focusing apparatus disposed within the bulk material an in alignment with at least a portion of the inside focusing apparatus.

Aspect 3. The apparatus unit of aspect 2, wherein, the inside focusing apparatus comprises a plurality of inside charge collections; and the outside focusing apparatus comprises a plurality of outside charge collections.

Aspect 4. The apparatus unit of aspect 3, wherein, each of the one or more outside charge collections has a negative charge; and each of the one or more inside charge collections has a positive charge.

Aspect 5. The apparatus unit of any one of aspects 2 to 4, wherein the outside focusing apparatus surrounds at least a portion of the first channel and at least a portion of the throat.

Aspect 6. The apparatus unit of any one of aspects 2 to 5, wherein the throat further comprises: a first channel disposed within the bulk material and extending from a first opening to the first throat opening opposite the first opening; and/or a second channel disposed within the bulk material extending from the second throat opening to a second opening.

Aspect 7. The apparatus unit of aspect 6, wherein throat comprises the first channel and the inside apparatus is disposed within at least a portion of the first channel.

Aspect 8. The apparatus unit of any one of aspects 6 to 7, wherein each of the first channel, the throat, the second channel, and the inside apparatus are cylindrical in shape.

Aspect 9. The apparatus unit of any one of aspects 6 to 8, wherein the inside apparatus extends at least from the first opening to within at least a portion of the throat.

Aspect 10. The apparatus unit of any one of aspects 6 to 9, wherein the first channel, the throat, the second channel, and the inside apparatus are symmetrically aligned on a common axis.

Aspect 11. The apparatus unit of any one of aspects 6 to 10, wherein each of the first channel, the throat, and the second channel comprise a circular cross-section.

Aspect 12. The apparatus unit of any one of aspects 6 to 11, wherein the cross-sectional area of the throat is less than a cross-sectional area of the first opening and a cross-sectional area of the second opening.

Aspect 13. The apparatus unit of any one of aspects 1 to 12, wherein the throat comprises a width that is less than 1000 times the mean free path length of the objects of interest before interacting with the apparatus unit.

Aspect 14. The apparatus unit of any one of aspects 1 to 12, wherein the throat comprises width that is less than 100 times the mean free path length of the objects of interest before interacting with the apparatus unit.

Aspect 15. The apparatus unit of any one of aspects 1 to 14, wherein the throat has a length on the order of one free mean path length of the objects of interest before interacting with the apparatus unit.

Aspect 16. The apparatus unit of any one of aspects 1 to 15, wherein the first focusing apparatus is disposed in proximity to the first throat opening and is configured to pull objects of interest toward the bulk material in proximity to the first throat opening.

Aspect 17. The apparatus unit of any one of aspects 1 to 16, wherein the first focusing apparatus is disposed in proximity to the first throat opening and is configured to repel the objects of interest away from the bulk material in proximity to the first throat opening.

Aspect 18. The apparatus unit of any one of aspects 1 to 17, further comprising a second focusing apparatus disposed within the bulk material and in proximity to the second throat opening.

Aspect 19. The apparatus unit of any one of aspects 1 to 18, wherein the second focusing apparatus is configured to pull objects of interest toward the bulk material in proximity to the second throat opening.

Aspect 20. The apparatus unit of any one of aspects 1 to 19, wherein the second focusing apparatus is configured to repel the objects of interest away from the bulk material in proximity to the second throat opening.

Aspect 21. The apparatus unit of any one of aspects 1 to 20, wherein the second focusing apparatus comprises one or more charge collections or one or more dipole collections.

Aspect 22. The apparatus unit of aspect 21, wherein the one or more charge collections are disposed within the bulk material.

Aspect 23. The apparatus unit of any one of aspects 21 to 22, wherein each of the one or more charge collections are in the shape of an annular ring.

Aspect 24. The apparatus unit of any one of aspects 18 to 23, wherein the second focusing apparatus is configured to generate an electromagnetic field magnitude gradient.

Aspect 25. The apparatus unit of aspect 24, wherein, the electromagnetic field magnitude gradient has a maximum in proximity the first throat opening; the electromagnetic field magnitude gradient has a minimum in proximity the first throat opening; the electromagnetic field magnitude gradient has a maximum toward a center of the focusing apparatus; or the electromagnetic field magnitude gradient has a minimum toward a center of the focusing apparatus.

Aspect 26. The apparatus unit of any one of aspects 24 to 25, wherein the electromagnetic field comprises an electrical field, a magnetic field, or a combination thereof.

Aspect 27. The apparatus unit of any one of aspects 1 to 26, wherein the first focusing apparatus comprises one or more charge collections.

Aspect 28. The apparatus unit of aspect 27, wherein each of the one or more charge collections is independently in the shape of an annular ring and/or a segment of an annular ring.

Aspect 29. The apparatus unit of any one of aspects 27 to 28, wherein each of the one or more charge collections is electrically insulated from the bulk material.

Aspect 30. The apparatus unit of any one of aspects 27 to 29, wherein each of the one or charge collections comprise an electrically conductive material.

Aspect 31. The apparatus unit of any one of aspects 27 to 30, wherein each the one or more outside charge collections is interconnected to an electrical potential.

Aspect 32. The apparatus unit of any one of aspects 27 to 31, wherein each of the one or more charge collections comprise embedded electrons or ions in an electrically insulating or semiconducting material.

Aspect 33. The apparatus unit of any one of aspects 27 to 32, wherein the one or more inside charge collections are configured to produce an electric field magnitude gradient.

Aspect 34. The apparatus unit of aspect 33, wherein the electric field magnitude gradient increases toward the throat opening.

Aspect 35. The apparatus unit of any one of aspects 33 to 34, wherein the electric field magnitude gradient increases toward the center of the plurality of inside charge collections.

Aspect 36. The apparatus unit of any one of aspects 1 to 35, wherein the first focusing apparatus is configured to generate an electromagnetic field magnitude gradient.

Aspect 37. The apparatus unit of aspect 36, wherein, the electromagnetic field magnitude gradient has a maximum in proximity the first throat opening; the electromagnetic field magnitude gradient has a minimum in proximity the first throat opening; the electromagnetic field magnitude gradient has a maximum toward a center of the focusing apparatus; or the electromagnetic field magnitude gradient has a minimum toward a center of the focusing apparatus.

Aspect 38. The apparatus unit of any one of aspects 36 to 37, wherein the electromagnetic field comprises an electrical field, a magnetic field, or a combination thereof.

Aspect 39. The apparatus unit of any one of aspects 1 to 38, wherein the bulk material comprises a metal, a metal alloy, a ceramic, a composite, a thermoplastic, a thermoset, a semiconducting material, electrically insulating material, a semiconducting material, an electrically insulating material, a glass, or a combination of any of the foregoing.

Aspect 40. The apparatus unit of any one of aspects 1 to 39, wherein inner surfaces of the bulk material are configured to reflect at least a portion of objects of interest.

Aspect 41. The apparatus unit of any one of aspects 1 to 40, wherein the objects of interest comprise electrically charged objects of interest comprise electrons, ions or charged dust particles or aerosols, or permanent or induced electric dipoles, atoms, or molecules or permanent or induced magnetic dipoles, or combinations of any of the foregoing.

Aspect 42. The apparatus unit of any one of aspects 1 to 41, wherein the objects of interest are polarized.

Aspect 43. The apparatus unit of any one of aspects 1 to 41, wherein the objects of interest comprises a permanent charge.

Aspect 44. The apparatus unit of any one of aspects 1 to 41, wherein the objects of interest are neutral.

Aspect 45. The apparatus unit of any one of aspects 1 to 44, wherein the apparatus unit is configured to change a property of the objects of interest in proximity the first throat opening and/or the second throat opening.

Aspect 46. The apparatus unit of aspect 45, wherein the property is the number density of the objects of interest at the first throat opening and/or the second throat opening.

Aspect 47. The apparatus unit of any one of aspects 45 to 46, wherein the change in the property is induced by interaction with the first focusing apparatus.

Aspect 48. The apparatus unit of aspect 45, wherein the property is a vector property of the objects of interest at the first throat opening and/or the second throat opening.

Aspect 49. The apparatus unit of aspect 48, wherein the objects of interest comprise photons, electrons, objects having a permanent or induced electric dipole, objects having a permanent or induced magnetic dipole, objects having as a polarization axis, or a combination of any of the foregoing.

Aspect 50. The apparatus unit of any one of aspects 48 to 49, wherein changing a vector property comprises changing the orientation of the objects of interest with respect to the geometry of the first throat opening and/or the second throat opening.

Aspect 51. The apparatus unit of any one of aspects 1 to 50, wherein, the objects of interest comprise a first property before entering the throat from a first direction; and the objects of interest comprise a second property before entering the throat from a second direction, wherein the first property is different than the second property.

Aspect 52. The apparatus unit of any one of aspects 1 to 51, wherein the first throat opening is diffusively coupled to a first reservoir with respect to the objects of interest of interest; and the second throat is diffusively coupled to a second reservoir with respect to the objects of interest of interest.

Aspect 53. The apparatus unit of aspect 52, wherein each of the first reservoir and the second reservoir independently comprises an electromagnetic field.

Aspect 54. The apparatus unit of any one of aspects 52 to 53, further comprising: a first reservoir focusing/defocusing apparatus within the first reservoir and in proximity to the first throat opening; and/or a second reservoir focusing/defocusing apparatus within the second reservoir and in proximity to the second throat opening.

Aspect 55. The apparatus unit of aspect 54, wherein each of the first reservoir and second reservoir focusing/defocusing apparatus is independently configured to focus a trajectory of the objects of interest from a reflection trajectory to a transmission trajectory.

Aspect 56. The apparatus unit of aspect 54, wherein each of the first reservoir and second reservoir focusing/defocusing apparatus is independently configured to change a trajectory of the objects of interest in the first reservoir and/or the second reservoir prior to interaction with the apparatus unit.

Aspect 57. The apparatus unit of aspect 56, wherein changing a trajectory comprises changing the trajectory from a reflection trajectory to a transmission trajectory; or changing the trajectory from a transmission trajectory to a reflection trajectory.

Aspect 58. A system comprising two or more of the apparatus units of any one of aspects 1 to 57.

Aspect 59. The system of aspect 58, comprising a planar array of the apparatus units of claim 1.

Aspect 60. The system of aspect 59, wherein the system comprises a plurality of the planar arrays, wherein at least one of the planar arrays are disposed in a direction normal to another planar array.

Aspect 61. The system of any one of aspects 58 to 60, further comprising two or more of the apparatus units of claim 1 coupled in series.

Aspect 62. The system of aspect 61, wherein a second throat opening of a first apparatus unit is diffusively coupled to a first throat opening of a second apparatus unit.

Aspect 63. A method of selectively transmitting objects of interest from a first reservoir to a second reservoir, comprising: providing the apparatus unit of any one of aspects 1 to 57, wherein the first throat opening is diffusively coupled to the first reservoir and the second throat opening diffusively coupled to the second reservoir; and generating a force field by activating the first focusing apparatus, to thereby selectively transmit objects of interest from the first reservoir to the second reservoir.

Aspect 63. A method of selectively transmitting objects of interest from a first reservoir to a second reservoir, comprising: providing the system of any one of aspects 58 to 62, wherein the first throat opening is diffusively coupled to the first reservoir and the second throat opening diffusively coupled to the second reservoir; and generating a force field by activating the first focusing apparatus, to thereby selectively transmit objects of interest from the first reservoir to the second reservoir.

Aspect 1A. An apparatus unit for selectively transmitting objects of interest, wherein the apparatus unit comprises a bulk material; a throat disposed within the bulk material and extending from the first throat opening to a second throat opening; and a first alignment apparatus disposed in proximity to the throat, wherein the alignment apparatus is configured to align objects of interest with respect to the throat within less than 1000 mean free path lengths of the objects of interest from the first throat opening,

Aspect 2A. The apparatus unit of aspect 1A, wherein interaction of the objects of interest with the first alignment apparatus increases the probability the objects of interest pas through the throat.

Aspect 3A. The apparatus unit of any one of aspects 1A to 2A, wherein selectively transmitting comprises selectively transmitting based on a property of the objects of interest and/or a property of the objects of interest induced by the apparatus unit.

Aspect 4A. The apparatus unit of any one of aspects 1A to 3A, wherein selectively transmitting comprises reflecting and/or aligning.

Aspect 5A. The apparatus unit of any one of aspects 1A to 4A, wherein the apparatus unit further comprises: a first channel diffusively coupled to the first throat opening; and a second channel diffusively coupled to the second throat opening.

Aspect 6A. The apparatus unit of aspect 5A, wherein the first alignment apparatus comprises: at least one first collection of charge disposed within the bulk material and in proximity to a portion of the throat; at least one second collection of charge disposed within the bulk material and in proximity to the first channel; and a second alignment apparatus, wherein the second alignment apparatus comprises: at least one third collection of charge disposed within the bulk material and in proximity to a portion of the throat and in proximity to the second channel; and at least one fourth collection of charge disposed within the bulk material and in proximity to a portion of the throat and in proximity to the second channel.

Aspect 7A. The apparatus unit of any one of aspects 5A to 6A, wherein each of the first channel, the throat, and the second channel independently have a cross-section that is circular, square, rectangular, or polygonal.

Aspect 8A. The apparatus unit of any one of aspects 5A to 7A, wherein the throat comprises a cross-sectional shape of aligned objects of interest.

Aspect 9A. The apparatus unit of any one of aspects 5A to 8A, wherein each of the first channel, the throat, the second channel, and the inside apparatus are cylindrical in shape.

Aspect 10A. The apparatus unit of any one of aspects 5A to 6A, wherein a cross-sectional area of the throat is less than a cross-sectional area of the first channel and a cross-sectional area of the second channel.

Aspect 11A. The apparatus unit of any one of aspects 5A to 10A, wherein each of the first channel the throat and the second channel comprise a circular cross-section.

Aspect 12A. The apparatus unit of any one of aspects 5A to 11A, wherein the first channel, the throat, and the second channel are symmetrically aligned about a common axis.

Aspect 13A. The apparatus unit of any one of aspects 1A to 12A, wherein the throat has a cross-sectional area that is: larger than a smallest cross-sectional area of an object before interacting with the apparatus unit; and smaller than the largest cross-sectional area of the object after interacting with the apparatus unit.

Aspect 14A. The apparatus unit of any one of aspects 1A to 13A, wherein the bulk material comprises wherein the bulk material comprises a metal, a metal alloy, a ceramic, a composite, a thermoplastic, a thermoset, a semiconducting material, electrically insulating material, a semiconducting material, an electrically insulating material, a glass, or a combination of any of the foregoing.

Aspect 15A. The apparatus unit of any one of aspects 1A to 14A, wherein inner surfaces of the bulk material are configured to reflect the objects of interest.

Aspect 16A. The apparatus unit of any one of aspects 1A to 15A, wherein the first alignment apparatus is configured to generate an electromagnetic field aligned such that objects of interest interacting with the electromagnetic field have a higher probability of entering the throat

Aspect 17A. The apparatus unit of any one of aspects 1A to 16A, wherein the first alignment apparatus is configured to generate an electromagnetic field substantially aligned with a longitudinal axis of the throat.

Aspect 18A. The apparatus unit of any one of aspects 1A to 17A, wherein the first alignment apparatus is configured to generate an electromagnetic field substantially aligned orthogonal to a longitudinal axis of the throat.

Aspect 19A. The apparatus unit of any one of aspects 1A to 18A, wherein the first alignment apparatus comprises: at least one first charge and/or dipole collection disposed in proximity a portion of the throat, and/or at least one second charge and/or dipole collection disposed in proximity to the first channel and toward the first opening.

Aspect 20A. The apparatus unit of aspect 19A, wherein, the at least one first charge collection is positively charged; and the at least one second charge collection is negatively charged.

Aspect 21A. The apparatus unit of any one of aspects 19A to 20A, wherein each of the at least one first charge collections and each of the at least one second charge collection have the shape of an annular ring.

Aspect 22A. The apparatus unit of any one of aspects 19A to 21A, wherein each of the at least one first charge collections and each of the at least one second charge collections independently comprises a continuous annular ring or a discontinuous annular ring.

Aspect 23A. The apparatus unit of any one of aspects 19A to 22A, wherein each of the at least one first charge collections and each of the at least one second charge collections is electrically insulated from the bulk material.

Aspect 24A. The apparatus unit of any one of aspects 19A to 23A, wherein each of the at least one first charge collections and each of the at least one second charge collections comprise an electrically conductive material.

Aspect 25A. The apparatus unit of any one of aspects 19A to 24A, wherein each of the at least one first charge collections and each of the at least one second charge collections are interconnected to an electrical potential.

Aspect 26A. The apparatus unit of any one of aspects 19A to 25A, wherein each of the at least one first charge collections and each of the at least one second charge collections comprise electrons or ions embedded in an electrically insulating or semiconducting material.

Aspect 27A. The apparatus unit of any one of aspects 19A to 26A, wherein each of the at least one first charge collections and each of the at least one second charge collections comprise dipoles embedded within an electrically insulating or semiconducting host material.

Aspect 28A. The apparatus unit of aspect 27A, wherein the dipoles comprise permanent magnetic dipoles.

Aspect 29A. The apparatus unit of aspect 27A, wherein the dipoles comprise a current loop configured to generate a magnetic field

Aspect 30A. The apparatus unit of any one of aspects 1A to 29A, wherein the first alignment apparatus is configured to generate an electromagnetic field.

Aspect 31A. The apparatus unit of aspect 30A, wherein the electromagnetic field is configured to induce a dipole moment in the objects of interest.

Aspect 32A. The apparatus unit of any one of aspects 30A to 31A, wherein the electromagnetic filed is configured to align the objects of interest with the throat.

Aspect 33A. The apparatus unit of any one of aspects 30 to 32A, wherein the electromagnetic field is configured to change the shape of the objects of interest.

Aspect 34A. The apparatus unit of any one of aspects 30A to 33A, wherein the electromagnetic field is configured to modify the orientation of the objects of interest.

Aspect 35A. The apparatus unit of aspect 34A, wherein modifying the orientation comprises rotating a vector property of the objects of interest or modifying the magnitude of a vector property of the objects of interest.

Aspect 36A. The apparatus unit of aspect 35A, wherein the vector property comprises a polarization axis, a magnetic dipole axis, a principal axis as derived by an inertia tensor, or a geometric long axis as derived by the geometric shape of the objects of interest.

Aspect 37A. The apparatus unit of any one of aspects 30A to 36A, wherein the electromagnetic field is configured to exert moments or torques about the center of mass of the o objects of interest.

Aspect 38A. The apparatus unit of any one of aspects 30A to 37A, wherein the electromagnetic field is configured to generate a force field on the objects of interest.

Aspect 39A. The apparatus unit of any one of aspects 1A to 38A, wherein the apparatus unit comprises a second alignment apparatus disposed in proximity to the throat.

Aspect 40A. The apparatus unit of aspect 39A, wherein the second alignment apparatus is configured to generate an electromagnetic field orthogonal to a longitudinal axis of the throat.

Aspect 41A. The apparatus unit of any one of aspects 39A to 40A, wherein the second alignment apparatus comprises an electromagnetic alignment apparatus.

Aspect 42A. The apparatus unit of aspect 41A, wherein the electromagnetic alignment apparatus comprises a magnetic alignment apparatus.

Aspect 43A. The apparatus unit of any one of aspects 1A to 42A, wherein the objects of interest comprise particles.

Aspect 44A. The apparatus unit of aspect 43, wherein the particles comprise dust particles, soot particles, water droplets, water molecules, or a combination of any of the foregoing.

Aspect 45A. The apparatus unit of any one of aspects 1A to 44A, wherein the alignment occurs within less than 10 mean free path lengths of the objects of interest.

Aspect 46A. The apparatus unit of aspect 45, wherein the alignment occurs within a fraction of one mean free time of the objects of interest.

Aspect 47A. The apparatus unit of any one of aspects 1A to 46A, wherein the apparatus unit comprises one throat.

Aspect 48A. The apparatus unit of any one of aspects 1A to 46A, wherein the apparatus unit comprises two or more throats.

Aspect 49A. The apparatus unit of any one of aspects 1A to 48A, wherein. the first throat opening is diffusively coupled to a first reservoir; and the second throat opening is diffusively coupled to a second reservoir.

Aspect 50A. A system comprising two or more of the apparatus units of any one of aspects 1A to 49A.

Aspect 51A. The system of aspect 50A, comprising a planar array of the apparatus units.

Aspect 52A. The system of aspect 51A, wherein the system comprises a plurality of the planar arrays, wherein at least one of the planar arrays are disposed above another planar array.

Aspect 53A. The system of any one of aspects 50A to 52A, further comprising two or more of the apparatus units coupled in series.

Aspect 54A. The system of aspect 53A, wherein a second throat opening of a first apparatus unit is diffusively coupled to a first throat opening of a second apparatus unit.

Aspect 55A. A method of selectively transmitting objects of interest from a first reservoir to a second reservoir, comprising: providing the apparatus unit of any one of aspects 1A to 49A, wherein the first throat opening is diffusively coupled to the first reservoir and the second throat opening is diffusively coupled to the second reservoir; and generating a force field by activating the first alignment apparatus; thereby causing a selective transmission of the objects of interest from the first reservoir to the second reservoir.

Aspect 55A. A method of selectively transmitting objects of interest from a first reservoir to a second reservoir, comprising: providing the system of any one of aspects 50A to 54A, wherein the first throat opening is diffusively coupled to the first reservoir and the second throat opening is diffusively coupled to the second reservoir; and generating a force field by activating the first alignment apparatus; thereby causing a selective transmission of the objects of interest from the first reservoir to the second reservoir.

The embodiments and methods described in this paper are only meant to exemplify and illustrate the principles of the invention. This invention can be carried out in several different ways and is not limited to the examples, embodiments, arrangements, configurations, or methods of operation described in this paper or depicted in the drawings. This also applies to cases where just one embodiment is described or depicted. Those skilled in the art will be able to devise numerous alternative examples, embodiments, arrangements, configurations, or methods of operation, that, while not shown or described herein, embody the principles of the invention and thus are within its spirit and scope.

What is claimed is:

1. An apparatus unit for selectively transmitting objects of interest, wherein the apparatus unit comprises:
a bulk material;
a throat disposed within the bulk material and extending from a first throat opening to a second throat opening opposite the first throat opening; and wherein the throat has length that is less than 1000 mean free path lengths of the objects of interest before interacting with the apparatus unit; and
a first focusing apparatus, wherein the first focusing apparatus is disposed within the bulk material and in proximity to at least a portion of the throat.

2. The apparatus unit of claim 1, wherein the first focusing apparatus has a length on the order of one free mean path length of the objects of interest before interacting with the apparatus unit.

3. The apparatus unit of claim 1, wherein the first focusing apparatus is disposed in proximity to the first throat opening and is configured to pull objects of interest toward the bulk material in proximity to the first throat opening.

4. The apparatus unit of claim 1, wherein the first focusing apparatus is disposed in proximity to the first throat opening and is configured to repel the objects of interest away from the bulk material in proximity to the first throat opening.

5. The apparatus unit of claim 1, further comprising a second focusing apparatus disposed within the bulk material and in proximity to the second throat opening.

6. The apparatus unit of claim 5, wherein the second focusing apparatus comprises one or more charge collections.

7. The apparatus unit of claim 1, wherein the objects of interest comprise electrons, ions. charged dust particles, charged aerosols, permanent electric dipoles, induced electric dipoles, atoms, molecules, permanent magnetic dipoles, induced magnetic dipoles, or combinations of any of the foregoing.

8. The apparatus unit of claim 1, wherein the objects of interest comprise photons, electrons, objects having a permanent or induced electric dipole, objects having a permanent or induced magnetic dipole, objects having as a polarization axis, or a combination of any of the foregoing.

9. The apparatus unit of claim 1, wherein the apparatus unit is configured to change a property of the objects of interest in proximity the first throat opening and/or the second throat opening.

10. The apparatus unit of claim 9, wherein the property is the number density of the objects of interest at the first throat opening and/or the second throat opening.

11. The apparatus unit of claim 9, wherein the change in the property is induced by interaction with the first focusing apparatus.

12. The apparatus unit of claim 9, wherein the property is a vector property of the objects of interest at the first throat opening and/or the second throat opening.

13. The apparatus unit of claim 12, wherein changing a vector property comprises changing the orientation of the objects of interest with respect to the geometry of the first throat opening and/or the second throat opening.

14. The apparatus unit of claim 1, wherein
the first throat opening is diffusively coupled to a first reservoir with respect to the objects of interest of interest; and
the second throat is diffusively coupled to a second reservoir with respect to the objects of interest of interest.

15. The apparatus unit of claim 14, wherein each of the first reservoir and the second reservoir independently comprises an electromagnetic field.

16. The apparatus unit of claim 15, further comprising:
a first reservoir focusing/defocusing apparatus within the first reservoir and in proximity to the first throat opening; and/or
a second reservoir focusing/defocusing apparatus within the second reservoir and in proximity to the second throat opening.

17. A system comprising two or more of the apparatus units of claim 1.

18. The system of claim 17, comprising a planar array of the apparatus subunits of claim 1.

19. A method of selectively transmitting objects of interest from a first reservoir to a second reservoir, comprising:
providing the apparatus unit of claim 1, wherein the first throat opening is diffusively coupled to the first reservoir and the second throat opening diffusively coupled to the second reservoir; and
generating a force field by activating the first focusing apparatus,
to thereby selectively transmit objects of interest from the first reservoir to the second reservoir.
